(19) United States
(12) Patent Application Publication
(10) Pub. No.: US 2026/0257365 A1
(43) Pub. Date: Sep. 3, 2026

(54) System, Method, and Computer-Readable Medium for Facilitating Human-Robot Collaboration in Construction Through Natural Language Instruction Processing and Task Mapping

(71) Applicant: REGENTS OF THE UNIVERSITY OF MICHIGAN, Ann Arbor, MI (US)

(72) Inventors: Carol C. Menassa, Ann Arbor, MI (US); Vineet R. Kamat, Ann Arbor, MI (US); Somin Park, Arlington, TX (US); Xi Wang, Bryan, TX (US); Joyce Y. Chai, Ann Arbor, MI (US)

(21) Appl. No.: 19/548,895

(22) Filed: Feb. 24, 2026

Related U.S. Application Data
(60) Provisional application No. 63/765,404, filed on Feb. 28, 2025.

(51) Int. Cl. B25J 9/16; B25J 13/00

(52) U.S. Cl. CPC B25J 9/1679; B25J 9/1697; B25J 13/003; B25J 13/006

(57) ABSTRACT

A computing system facilitates human-robot collaboration in construction by receiving natural language instructions, processing them to extract task-specific information, mapping this information to construction tasks, and generating control signals for a robot. A method involves receiving natural language instructions, processing them to extract task information, mapping this to construction tasks, and generating control signals for a robot. A computer-readable medium includes instructions for receiving natural language instructions, processing to extract task information, mapping this to tasks, and generating robot control signals.

### CROSS-REFERENCE TO RELATED APPLICATIONS

This application claims the priority benefit under 35 U.S.C. § 119(e) of U.S. Provisional Application No. 63/765,404, filed Feb. 28, 2025, which is incorporated herein by reference in its entirety.

### GOVERNMENT SUPPORT

This invention was made with government support under 2025805 and 2128623 awarded by the National Science Foundation. The government has certain rights in the invention.

### FIELD OF THE INVENTION

The present aspects relate to facilitating human-robot collaboration in construction work, and more particularly, to systems and methods for processing and executing construction tasks based on natural language instructions, such as using a natural language understanding module to extract task-specific information from the instructions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the realm of construction, the integration of robotics has been identified as a pivotal strategy to mitigate labor shortages and enhance productivity. However, the dynamic, unstructured nature of construction sites, along with the variability of tasks, presents considerable challenges to the deployment and effective utilization of robots. Certain robotic systems, designed for repetitive tasks in controlled environments, may struggle to adapt to the unpredictable and evolving conditions of construction sites. This has necessitated the development of interfaces that facilitate seamless human-robot collaboration (HRC), allowing for intuitive interaction and communication between construction workers and robotic assistants. Yet, the complexity of designing interfaces that enable non-expert users to effectively command and collaborate with robots illustrates a gap in the current technological landscape.

Moreover, natural language-based interaction emerges as a promising avenue to bridge this gap, using the inherent human capability for communication. The construction industry, characterized by its reliance on human labor and expertise, stands to benefit from advancements that allow workers to instruct robots using natural language. This approach can potentially circumvent the need for specialized programming skills, thus democratizing the use of robotics on construction sites. However, the unique lexicon, syntax, and semantics of construction-related communication, coupled with the ambient noise and the specificity of tasks, pose substantial challenges to the development of robust natural language understanding (NLU) systems tailored for construction environments. The effectiveness of such systems is contingent upon their ability to accurately interpret instructions and translate them into actionable tasks, a non-trivial endeavor given the complexity and variability of natural language.

Given these challenges, there are evident opportunities for improved platforms and technologies for solving the identified conventional problems. The development of advanced HRC systems that seamlessly integrate NLU, information mapping, and robot control capabilities could significantly enhance the efficiency, safety, and adaptability of construction operations. Such systems would not only facilitate intuitive human-robot interaction but also contribute to overcoming the inherent limitations of current robotic deployments in the dynamic and complex domain of construction work.

### BRIEF SUMMARY OF THE INVENTION

In one aspect, a computing system for facilitating human-robot collaboration in construction work includes: (1) a processor; and (2) a memory that includes computer-executable instructions that, when executed by the processor, cause the computing system to (a) receive natural language instructions from a human worker; (b) process the received natural language instructions using a natural language understanding module to extract task-specific information; (c) map the extracted task-specific information to specific construction tasks and sequences using an information mapping system; and (d) generate control signals for a robot assistant to execute the mapped construction tasks based on the natural language instructions.

In another aspect, a computer-implemented method for facilitating human-robot collaboration in construction work includes: (1) receiving, by a computing system, natural language instructions from a human worker; (2) processing, by the computing system, the received natural language instructions using a natural language understanding module to extract task-specific information; (3) mapping, by the computing system, the extracted task-specific information to specific construction tasks and sequences using an information mapping system; and (4) generating, by the computing system, control signals for a robot assistant to execute the mapped construction tasks based on the natural language instructions.

In yet another aspect, a computer-readable medium includes instructions that, when executed by a computing system, cause the computing system to perform a method for facilitating human-robot collaboration in construction work, the method includes: (1) receiving natural language instructions from a human worker; (2) processing the received natural language instructions using a natural language understanding module to extract task-specific information; (3) mapping the extracted task-specific information to specific construction tasks and sequences using an information mapping system; and (4) generating control signals for a robot assistant to execute the mapped construction tasks based on the natural language instructions.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary system architecture designed to facilitate natural language-based interaction between human operators and robotic assistants for conducting pick-and-place construction operations, according to some aspects.

FIG. 2 illustrates an exemplary process within the Natural Language Understanding (NLU) module, specifically focusing on the task of slot filling, according to some aspects.

FIG. 3 depicts an exemplary representation of the Bidirectional Long Short-Term Memory (BiLSTM) with a Conditional Random Fields (CRF) layer, according to some aspects.

FIG. 4 depicts an exemplary process for fine-tuning a pre-trained Bidirectional Encoder Representations from Transformers (BERT) model for sentence tagging tasks, according to some aspects.

FIG. 5 depicts an exemplary Information Mapping (IM) module, according to some aspects.

FIG. 6 depicts an exemplary process flow for pick-and-place operations as implemented in the Robot Control (RC) module, according to some aspects.

FIG. 7 depicts an exemplary robot operation environment tailored for the installation of drywall panels, according to some aspects.

FIG. 8 depicts an exemplary representation of the position and dimension information of building components used in a case study for drywall installation, according to some aspects.

FIG. 9 depicts exemplary methods for placing drywall panels onto studs during construction, according to some aspects.

FIG. 10 depicts an exemplary representation of the detailed categorization of natural language instructions for drywall installation, according to some aspects.

FIG. 11 depicts an exemplary network architecture diagram for two distinct language models: BiLSTM-CRF and BERT, according to some aspects.

FIG. 12 depicts an exemplary representation of the performance evaluation of natural language understanding (NLU) models, according to some aspects.

FIG. 13 depicts an exemplary comparison of the performance of different models in interpreting natural language instructions for construction tasks, according to some aspects.

FIG. 14 depicts an exemplary pseudocode for the Information Mapping (IM) module, according to some aspects.

FIG. 15 illustrates pseudocode for determining the target drywall panel for pick-and-place operations based on identifiers (IDs) or positions, according to some aspects.

FIG. 16 illustrates the process for extracting information regarding a stud, according to some aspects.

FIG. 17 depicts an exemplary demonstration of drywall installation using three distinct layouts, according to some aspects.

FIG. 18 depicts an exemplary demonstration of a robot performing drywall installation tasks based on natural language instructions, according to some aspects.

FIG. 19 illustrates the application of the present techniques in executing drywall installation tasks for a second layout, according to some aspects.

FIG. 20 depicts an exemplary demonstration of the interaction between human workers and robotic assistants in the context of drywall installation, according to some aspects.

FIG. 21 depicts an exemplary graphical representation of the training accuracy for datasets that have been re-annotated to address co-reference issues in natural language instructions, according to some aspects.

FIG. 22 describes a computing environment for facilitating intuitive human-robot collaboration in construction work using natural language instructions, according to some aspects.

FIG. 23 depicts a computer-implemented method for facilitating human-robot collaboration in construction work, according to some aspects.

### DETAILED DESCRIPTION

### Overview and Advantages

Given the increasing complexity and demands of modern construction projects, the integration of robotic assistants into field construction work has emerged as a promising avenue to enhance efficiency, safety, and productivity. The dynamic and often unpredictable nature of construction sites, coupled with the diverse tasks and operations involved, presents unique challenges that necessitate innovative solutions for effective human-robot collaboration (HRC). This disclosure outlines a groundbreaking method that enables human workers, particularly those without expertise in robot programming, to intuitively interact with robotic assistants using natural language instructions. This approach not only democratizes the use of advanced robotic systems in construction but also significantly improves the adaptability and efficiency of robots in performing construction tasks, such as pick-and-place operations, which are pivotal in various construction activities including drywall installation.

The core of this method lies in its three integrated modules: Natural Language Understanding (NLU), Information Mapping (IM), and Robot Control (RC). These modules work in concert to translate natural language instructions from human workers into actionable commands that robotic assistants can execute with high precision. The NLU module leverages advanced algorithms to accurately interpret the intent and specifics of the instructions provided by human workers. Following this, the IM module maps these instructions onto specific tasks and sequences that the robot can understand, taking into account the dynamic and complex nature of construction sites. Finally, the RC module translates these mapped instructions into precise control signals for the robotic assistants, enabling them to perform the designated tasks efficiently.

The proposed method has been rigorously evaluated through a case study focusing on drywall installation, a common yet intricate construction task. The results of this evaluation have been highly promising, demonstrating over 99% accuracy in both the NLU and IM modules. This high level of accuracy ensures that the robotic assistants can perform tasks accurately based on the natural language instructions provided, thereby significantly reducing the likelihood of errors and rework. Such efficiency not only saves time and resources but also enhances the overall quality of construction work. By employing a natural language understanding module that achieves over 99% accuracy in interpreting instructions, the system ensures minimal processing delays and high reliability in understanding task-specific information. This high level of accuracy is in construction environments where the specificity of tasks and the accuracy of their execution can significantly impact overall project outcomes.

One of the most significant improvements this method offers is in processing efficiency. By enabling direct communication between human workers and robots through natural language, the need for intermediary programming or manual control is eliminated. This direct form of interaction streamlines the task delegation process, allowing for quicker adaptation to changes and unexpected conditions on the construction site. Furthermore, the method's reliance on natural language instructions reduces the cognitive load on human workers, making it easier for them to interact with and control the robots without the need for extensive training or technical knowledge.

The method significantly enhances memory usage within the system. By intelligently processing and mapping natural language instructions to specific robot actions, the system ensures that only relevant data is stored and used for task execution. This not only optimizes the use of computing resources but also enables the system to quickly adapt to new instructions or changes in the task environment without the need for extensive reprogramming or data processing. By employing advanced algorithms that can accurately extract and map task-specific information from natural language instructions, the system minimizes the need for extensive data storage and retrieval operations. This not only speeds up the task execution process but also reduces the computational load on the system, allowing for more complex tasks to be handled simultaneously without compromising performance.

In some aspects, the present techniques focus on enhancing human-robot collaboration (HRC) in construction environments through a computing system that leverages natural language instructions. This system is designed to bridge the communication gap between human workers and robot assistants, enabling a more intuitive and efficient interaction that does not require specialized knowledge in robot programming. The core of these techniques lies in the processing and interpretation of natural language instructions into actionable tasks for robot assistants, facilitated by a series of interconnected modules including a natural language understanding module, an information mapping system, and a robot control unit.

The integration of sensors and cameras further contributes to the system's efficiency by providing environmental feedback and monitoring the status of construction tasks. This real-time feedback allows for immediate adjustments to be made to the robot assistant's actions, ensuring that tasks are performed accurately and safely. Additionally, the use of a speech recognition module and a user interface device enhances the interaction between the human worker and the robot assistant, making the collaboration more effective and user-friendly. The present techniques represent a significant advancement in the field of human-robot collaboration in construction work. By using natural language instructions and advanced computing technologies, the system offers a solution that improves processing efficiency, network usage, and memory usage, thereby addressing some of the key challenges in implementing robotics in construction environments.

### Exemplary Computing Architecture

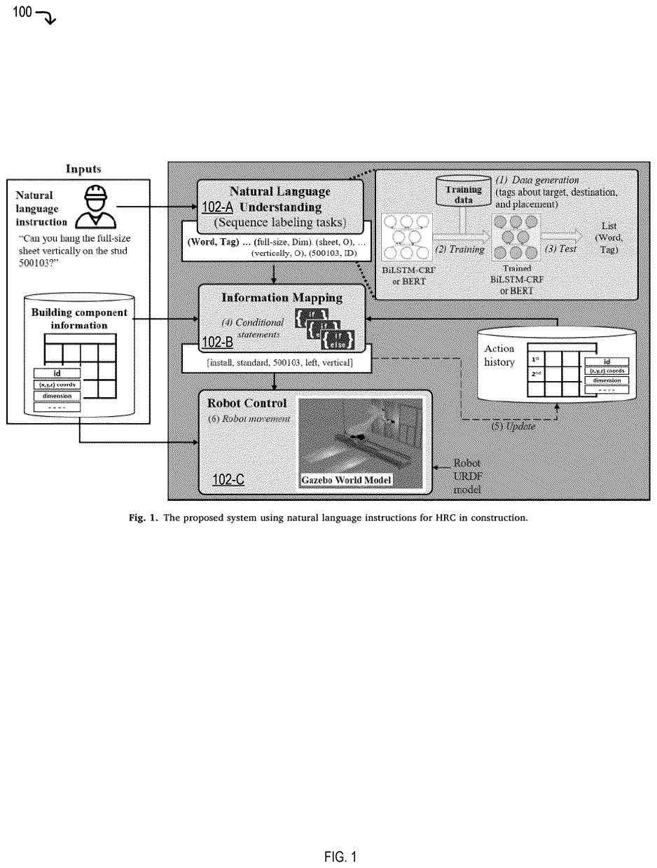

FIG. 1 depicts an exemplary system architecture 100 designed to facilitate natural language-based interaction between human operators and robotic assistants for conducting pick-and-place construction operations. The system architecture 100 may include inputs (e.g., natural language instructions from a human worker and/or building component information) and processing modules. The processing modules may include a Natural Language Understanding (NLU) module 102-A, an Information Mapping (IM) module 102-B, and a Robot Control (RC) module 102-C, each playing a role in translating human instructions into actionable tasks performed by the robot.

In some embodiments, the NLU module 102-A serves as the initial point of interaction, where it may receive verbal instructions from human operators. The NLU module 102-A may include a language model (e.g., Bidirectional Long Short-Term Memory with Conditional Random Fields (BiLSTM-CRF) model and/or a Bidirectional Encoder Representations from Transformers (BERT) model), trained to perform sequence labeling tasks. The language model may generate word-tag pairs from the natural language instructions provided by a human operator, wherein each word in an instruction is assigned to a corresponding semantic tag. For example, in the instruction “hang the full-size sheet vertically on the stud 500103,” the word “full-size” may be tagged as a dimension (Dim), and “500103” may be tagged as an identifier (ID). As such, these word-tag pairs may enable identification of specific commands and contextual cues (e.g., the target object, the destination, and/or the placement orientation) within the instructions, which are useful for the subsequent stages of task execution.

The Information Mapping (IM) module 102-B may further process the interpreted instructions. The IM module 102-B may integrate the output from the NLU module 102-A with additional contextual information, such as building component data from Building Information Modeling (BIM) and/or historical action records. As used herein, the term “Building Information Modeling” or “BIM” may refer to digital representations of physical and functional characteristics of building components, including identification numbers, dimensions, and spatial coordinates. The IM module 102-B may employ conditional statements to map the word-tag pairs from the NLU module 102-A to specific task parameters. For example, the IM module 102-B may generate output specifying the target object, the destination identification number, and the placement method, such as “[install, standard, 500103, left, vertical].” The IM module 102-B may also update the action history record based on completed tasks. The Robot Control (RC) module 102-C may then use these task parameters to generate precise executable robot control commands relevant to the current task and site conditions.

In some embodiments, the RC module 102-C may translate the mapped task parameters into robot movement commands. The RC module 102-C may receive the detailed task information provided by the IM module 102-B, including the target object, final location, and placement method, and may control the robot's movements to execute the pick-and-place tasks. In some embodiments, the RC module 102-C may interface with a simulation environment, such as Gazebo World Model, and may utilize a Robot URDF (Unified Robot Description Format) model to generate precise robot movements. This module may leverage the robot's capabilities to handle minor adjustments and navigate uncertainties within the workspace, enabling efficient and accurate task completion without requiring explicit instructions for every minor adjustment.

In some embodiments, the system architecture 100 is designed to enable intuitive and efficient communication between human operators and robotic assistants. By using natural language instructions, the system architecture 100 enables human operators, who may not have expertise in robot programming, to convey task requirements to the robot. The system architecture 100 may integrate the NLU module 102-A, the IM module 102-B, and/or the RC module 102-C to facilitate effective human-robot collaboration in construction settings. Through this integration, the present techniques bridge the communication gap between human operators and robotic assistants, and may contribute to improved productivity and safety in construction work. In some embodiments, the system architecture 100 may further include hardware components such as microphones for capturing natural language instructions, sensors and cameras for providing environmental feedback, and/or communication network hardware for facilitating real-time data exchange between the modules and the robot assistant.

The present techniques may include a computer-implemented method for enhancing Human-Robot Collaboration (HRC) in construction settings through natural language instructions. In some embodiments, the computer-implemented method may allow human workers, who may not have expertise in robot programming, to intuitively communicate with robotic assistants for executing pick-and-place construction operations. The computer-implemented method may include receiving natural language instructions from a human worker, processing the instructions using the NLU module 102-A to extract task-specific information, mapping the extracted information to specific construction tasks using the IM module 102-B, and/or generating control signals for a robot assistant using the RC module 102-C.

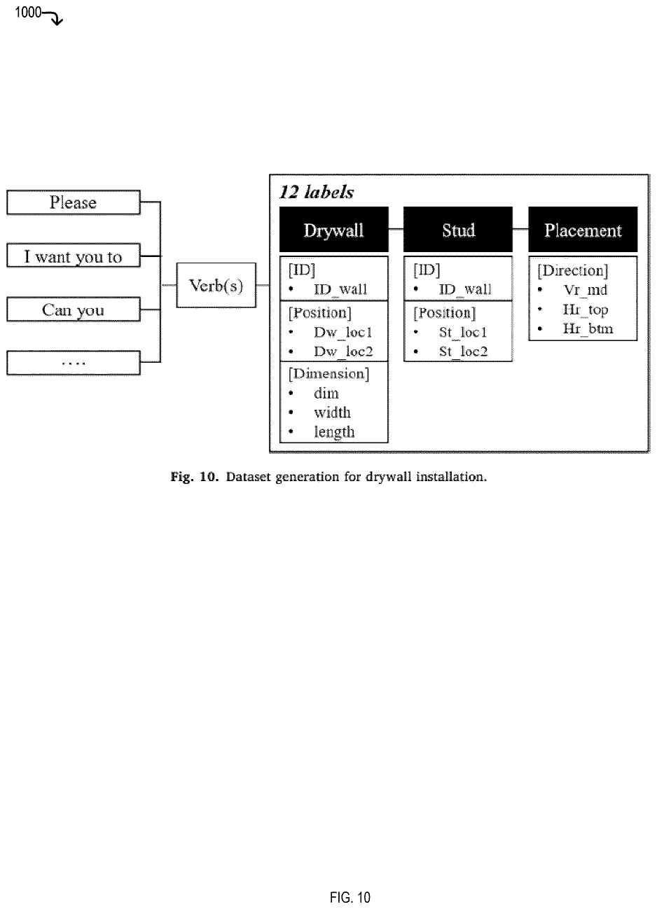

In some aspects, the computer-implemented method may include a dataset generation and labeling process using the NLU module 102-A. The dataset generation and labeling process may generate natural language instructions that contain pertinent pieces of information (e.g., target, destination, and placement method) required for pick-and-place construction tasks. The computer implemented method may label these instructions to identify attributes such as ID, dimension, and position of workpieces, which may enable the robots to accurately execute the tasks. For example, as depicted in FIG. 10, the labels may include tags for drywall attributes (such as ID_wall, dim, width, and length), stud attributes (such as ID and St_loc1), and placement orientation (such as Vr_md for vertical middle, Hr_top for horizontal top, and Hr_btm for horizontal bottom). The labeling process aids in ensuring that each piece of task-specific information is uniquely identified, which assists in resolving potential co-reference issues and may enable the NLU module 102-A to effectively interpret the instructions provided by human operators. As used herein, “co-reference issues” may refer to situations where an instruction references a previously mentioned object (e.g., “the previous panel”) rather than explicitly identifying the object by ID or dimension.

### Exemplary Slot Filling Instruction

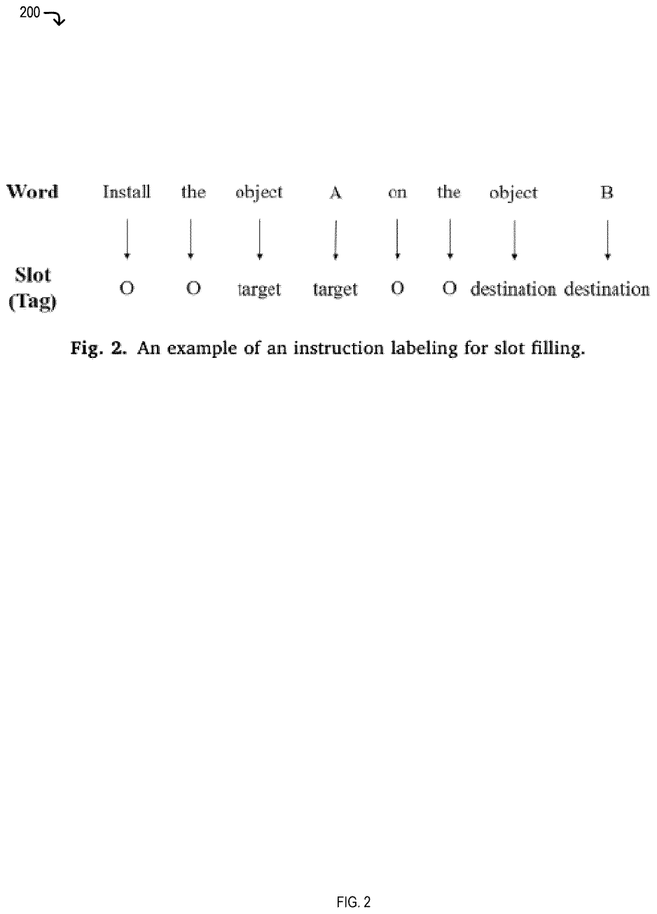

FIG. 2 illustrates an exemplary process 200 within the NLU module 102-A, specifically focusing on the task of slot filling. As used herein, the term “slot filling” may refer to a natural language processing technique that extracts semantic constituents from a user's command by assigning semantic tags (or “slots”) to words, thereby identifying key pieces of information such as the target object, its intended destination, and the placement orientation. In some aspects, slot filling may be a function of the NLU module 102-A, where it aims to extract semantic constituents from a user's command, which is presented in natural language. The process 200 may enable identification of key pieces of information such as the target object, its intended destination, and the placement orientation, which are for executing construction tasks effectively.

In the depicted example, the user command “Install the object A on the object B” undergoes analysis on a word-level basis. Each word in the command is assigned a ‘tag’, which serves as a semantic label identifying the role of the word within the context of the instruction. The goal of slot filling is to generate pairs of words and their corresponding tags, thereby structuring the user's command into a format that can be further processed by the system.

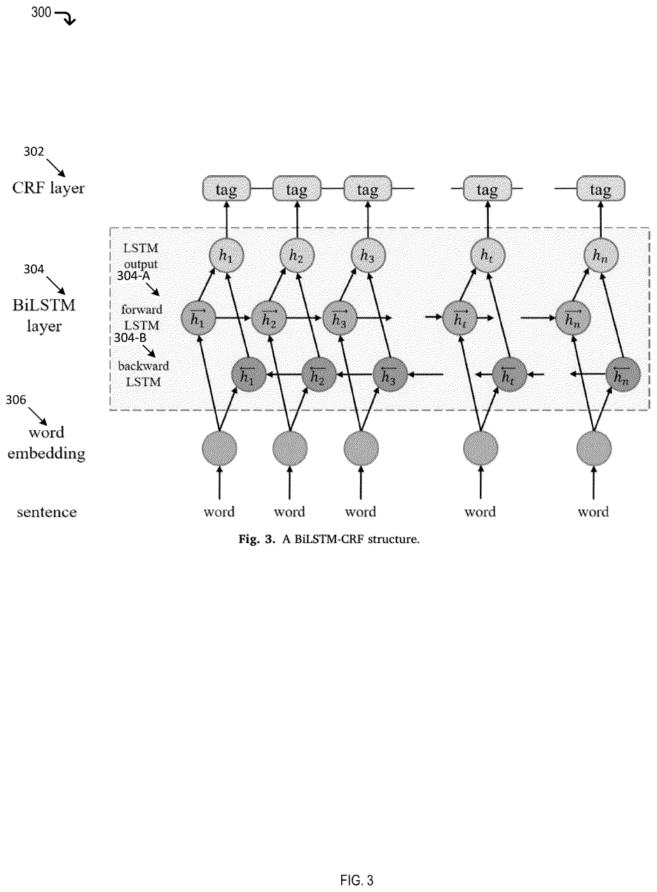

The present techniques may evaluate two distinct language models to perform the slot filling task, aiming to determine the most effective approach for accurately tagging each word in the user command. In some embodiments, the first model may include a combination of the BiLSTM combined with a Conditional Random Fields (CRF) layer. As depicted in FIG. 3, the BiLSTM-CRF model may leverage both past and future context by processing the sequence of words in both forward and backward directions. In some embodiments, the first model may first convert input words into word embeddings, which the forward and backward LSTM layers may then process to generate hidden states for each position in the sequence. This dual processing advantageously enables the model to capture a comprehensive understanding of the sequence, which the CRF layer may then use to generate a coherent sequence of tags that consider the relationships between adjacent tags.

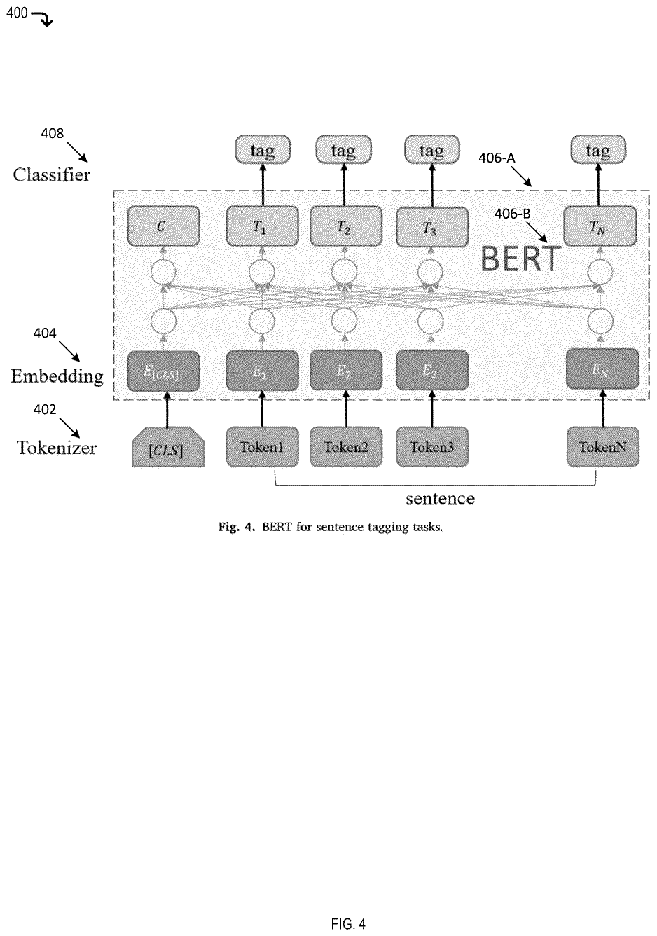

In some embodiments, the second model is based on the BERT architecture. As depicted in FIG. 4, BERT may employ a multilayer transformer structure that relies on an attention mechanism to analyze the context of each word in a sentence from both left and right sides. This bidirectional context understanding may enable BERT to predict the semantic tags for each word with a high degree of accuracy. In some embodiments, the second model is pre-trained on a large-scale dataset and fine-tuned for the specific task of sentence tagging, which may make it adaptable to the nuances of construction-related commands.

The process of slot filling, as demonstrated in FIG. 2, may enable the NLU module 102-A to interpret natural language instructions by assigning semantic tags to each word in a user command. The IM module 102-B may then process this structured information to facilitate control of robotic assistants in construction tasks.

### Exemplary BiLSTM-CRF Instruction

FIG. 3 depicts an exemplary representation 300 of the BiLSTM with a CRF layer 302 which may be a component of the NLU module 102-A. FIG. 3 illustrates how the forward and backward LSTM layers may use both past and future context to enhance the accuracy of slot filling tasks.

In some embodiments, the BiLSTM model 304 may include: a forward LSTM layer 304-A and a backward LSTM layer 304-B. The input sentence may first be converted into word embeddings 306, which may then be processed by both LSTM layers. The forward LSTM layer 304-A may process the input sequence from the beginning to the end (e.g., left to right), while the backward LSTM layer 304-B processes the input sequence in the reverse direction (e.g., right to left). This dual approach enables the model to capture information from both directions, generating hidden states that represent the context surrounding each word in the sentence. As used herein, the term “hidden state” may refer to an internal representation computed by a recurrent neural network layer, such as an LSTM layer, at each position in a sequence. The hidden state may encode information about the input at that position as well as contextual information from other positions in the sequence. In a forward LSTM layer, the hidden state may encode information from preceding positions, while in a backward LSTM layer, the hidden state may encode information from subsequent positions.

In some embodiments, the forward LSTM layer 304-A computes a hidden state for each position (t) in the sequence, denoted as (\vec{h}ₜ), based on the current word embedding 306 and the previous hidden state (\vec{h}ₜ₋₁). Similarly, the backward LSTM layer 304-B may compute a hidden state (\acute{h}ₜ) considering the current word embedding input and the subsequent hidden state (\acute{h}ₜ₊₁) The BiLSTM model 304 may then concatenate these hidden states from both layers to form a combined feature representation for each position in the sequence.

Once the CRF layer 302 receives this combined feature representation, the CRF layer 302 may generate the final sequence labeling results. The CRF layer 302 may consider the dependencies between tags in the sequence, which may enable the CRF layer 302 to enforce constraints that ensure the generated tag sequence is plausible. For example, the CRF layer 302 may ensure that certain tags are more likely to follow others, based on the relationships learned from the training data. This capability significantly enhances the model's ability to accurately predict the correct sequence of tags for a given input sentence.

### Exemplary Computer-Implemented Machine Learning Model Fine-Tuning

FIG. 4 depicts an exemplary architecture 400 for fine-tuning a pre-trained BERT model 406-B for sentence tagging tasks. As depicted in FIG. 4, the architecture 400 may include Tokenizer layer 402, an Embedding layer 404, a BERT encoder module 406-A, and/or a Classifier layer 408.

In some embodiments, the Tokenizer Layer 402 may serve as an initial processing stage that tokenizes the input sentence into individual tokens. During this tokenization process, a special token, such as [CLS] for classification, may be added at the beginning of the sequence, and/or a [SEP] token may be added at the end of the sequence to indicate sentence boundaries. In some cases, the Tokenizer Layer 402 may further break down words into subwords or sub-tokens based on the tokenization vocabulary, which may enable the model to handle out-of-vocabulary words and capture morphological variations.

Following the tokenization process, the Embedding layer 404 may receive the tokenized sequence and convert each token into a corresponding embedding representation (e.g., E[CLS], E1, E2, . . . EN). The embedding representation for each token may combine a token embedding, a segment embedding, and a position embedding, which may allow the model to capture both the meaning of each token and its position within the sequence. This combination of embeddings may provide a rich representation that encodes semantic and positional information, thereby preparing the tokenized input for deeper contextual analysis by subsequent processing stages.

Following the generation of embedding representations, the BERT encoder module 406-A may receive these embeddings for subsequent processing. In some embodiments, the BERT encoder module 406-A, which may include multiple stacked encoders (e.g., 12 encoder layers), may process these embeddings through a series of multi-head attention mechanisms and/or feed-forward networks. Each encoder layer may apply self-attention to capture relationships between all tokens in the sequence, regardless of their distance from one another. This self-attention mechanism may allow the model to consider the full context of the input sentence when generating output representations, thereby enabling the model to understand how different words in a construction instruction relate to one another and contribute to the overall meaning of the command.

As a result of this processing, the BERT encoder module 406-A may generate output representations (e.g., C, T1, T2, . . . TN) for each token position. In some aspects, the output representation C, corresponding to the [CLS] token, may capture aggregated sequence-level information that may be useful for understanding the overall intent of the instruction. The output representations T1, T2, . . . TN may capture token-level contextual information for each respective token in the input sequence, which may then be utilized by subsequent layers for slot filling and semantic tagging tasks.

Following the generation of these output representations by the BERT encoder module 406-A, the Classifier layer 408, which may be a linear layer, may receive the token-level representations and assign a semantic tag to each token position. In some embodiments, the Classifier layer 408 may process the contextual information encoded in the output representations to determine the appropriate tag for each token, thereby generating the word-tag pairs used for slot filling in the NLU module 102-A. This classification process may enable the system to identify key semantic constituents within the natural language instructions, such as target objects, destinations, and placement orientations, which may then be utilized by subsequent modules for task mapping and robot control.

In some aspects, a word in the input sentence may be composed of multiple tokens due to the subword tokenization process performed by the Tokenizer Layer 402. In scenarios where the Classifier layer 408 generates differing tag predictions for these tokens, the tag for the word may be determined based on a majority of the token-level predictions. This approach may allow the model to handle words that are broken down into subwords during tokenization, thereby maintaining the integrity of the semantic information extracted from the instructions.

### Exemplary Information Mapping

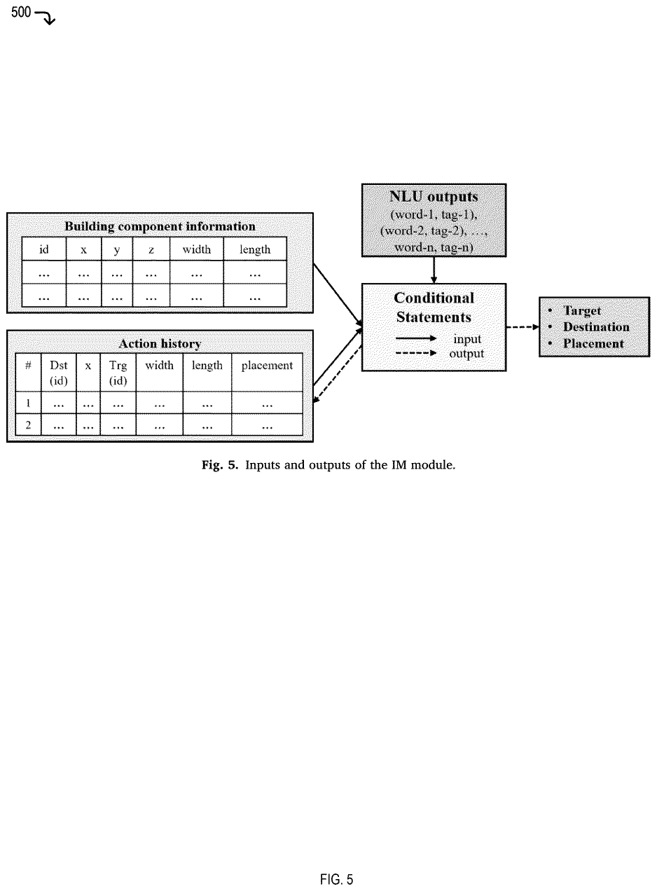

FIG. 5 depicts an exemplary Information Mapping (IM) module 500, which translates the output from a Natural Language Understanding (NLU) module (e.g., the module 102-A of FIG. 1) into actionable commands for a robotic system. The module 500 may correspond to the module 102-B of FIG. 1. These two modules enable the robot to interpret and act upon the instructions provided by human workers in natural language. The IM module functions by integrating three key types of information: the identification of a target object, its intended destination, and the desired placement orientation. These pieces of information parameterize the successful execution of pick-and-place construction operations, in some aspects.

The process within the IM module 500 begins with the outputs from the NLU module, which consist of word-tag pairs that identify semantic information such as the target object, destination, and placement orientation. However, these word-tag pairs are not directly executable by robotic systems. Therefore, the IM module employs conditional statements to map these NLU outputs to specific, actionable commands. These conditional statements are designed to address any discrepancies in vocabulary between the words used in the NLU outputs and the terminology found in building component information and action history records.

For instance, if the NLU module identifies a word with the tag ‘ID_target’, which corresponds to the identification number of a target object, the IM module maps this identification number to the relevant object in the building component information. This mapping process ensures that the robot receives precise instructions regarding which object to interact with. Similarly, if the NLU output includes a tag related to the position of the target object, such as ‘Position_target’, the IM module maps this information to a specific location within the construction site, as defined in the building component information.

The action history record (ActHist), which is updated by the IM module 500, includes detailed information about previously installed objects, such as their identification numbers, dimensions, placement locations, and methods. This historical data is utilized in conjunction with the current NLU outputs to refine the mapping process, ensuring that the robot receives clear and accurate instructions for the current task. For example, when a worker's instruction refers to a “previously installed” panel, the information mapping module 102-B may retrieve the last performed operation's target from the action history record to identify the object and its characteristics, thereby resolving co-referential instructions.

Once the mapping process is complete, the IM module 500 generates a final command that specifies the type of target object, its destination identification number, and the method of placement. This command is then relayed to the Robot Control (RC) module, which executes the task according to the instructions.

The effectiveness of the IM module is heavily dependent on the accuracy of the NLU module's outputs. Any inaccuracies or misinterpretations in the NLU results can lead to errors in the mapping process, potentially compromising the robot's ability to correctly execute the task. Therefore, the IM module's performance can be intrinsically linked, in some aspects, to the precision of the NLU module, highlighting the importance of accurate natural language understanding in the overall success of human-robot collaboration in construction tasks.

### Exemplary Pick-and-Place for Robot Control

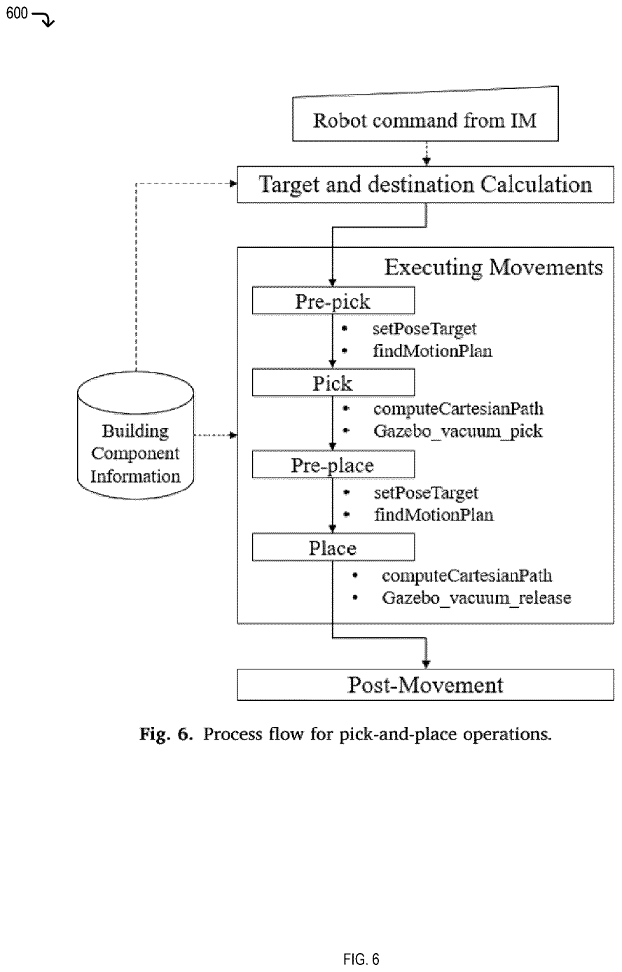

FIG. 6 depicts an exemplary process flow 600 for pick-and-place operations as implemented in a Robot Control (RC) module (e.g., the RC module 102-C), for enabling natural language-based human-robot collaboration in construction tasks. The figure illustrates the sequence of steps a robot follows to execute tasks based on natural language instructions and building component information processed by preceding modules, specifically focusing on the calculation of precise coordinates for the target and destination. This calculation enables translating abstract instructions into actionable data for task execution, utilizing geometric points and dimension information derived from the building component information.

In this process, a virtual robot, simulated using the Robot Operating System (ROS) and Gazebo—a virtual environment provided by the Open-Source Robotics Foundation—performs the operations. The robot, a 6 degrees-of-freedom KUKA robotic arm, executes movements informed by methodologies described in prior research. The robot's movements are executed through a series of phases to ensure precise handling and placement of objects as per the instructions received.

Initially, the robot establishes a pose target and devises a motion plan. The robot arm first attempts to find a motion from its original base location. If the initial plan proves unfeasible, the robot's base position is adjusted accordingly in the Pre-Pick phase. Once a valid path for the robot's base is determined, a motion plan for the movement of the robotic arm is generated, ensuring that the robot's end-effector aligns precisely with the center of the target object. At this stage, the orientation of the end-effector is not yet adjusted according to the target object's arrangement.

Subsequently, a Cartesian path is computed for the robot's end-effector to secure the target object with a gripper in the Pick phase. The robot then follows the computed path to move to the target object. Reflecting the Pre-Pick stage, calculated destination and placement method are used to adjust the pose target and motion plan in the Pre-Place phase. The orientation of the end-effector is adjusted for the placement method, with the specific rotation of the sixth link being dictated by whether the placement is vertical or horizontal.

Following this, the robot follows the determined Cartesian path to place the object at the designated location and releases it in the Place phase. After the placement, the robot arm reverts to its pre-placement stance in the Post-Movement phase. Throughout these stages, the robotic arm's movement, generated by MoveIt, has higher priority than the base movement to reduce localization error. This means that the robot's base is only repositioned if the robotic arm fails to devise a feasible motion plan for picking or placing an object.

The Open Motion Planning Library (OMPL) and Flexible Collision Library are employed to compute kinematics of each joint in planning movements, ensuring collision-free trajectories. When the robot is carrying a target object, a collision checking process is applied while the target is considered as part of the robot, so that the robot and the target object will not collide with their surroundings. Upon successfully completing the installation, a human operator may give the next instructions after target placement is completed, facilitating continuous and efficient task execution. This process exemplifies the integration of natural language instructions with robotic control in construction tasks, highlighting the potential for enhancing human-robot collaboration in the field.

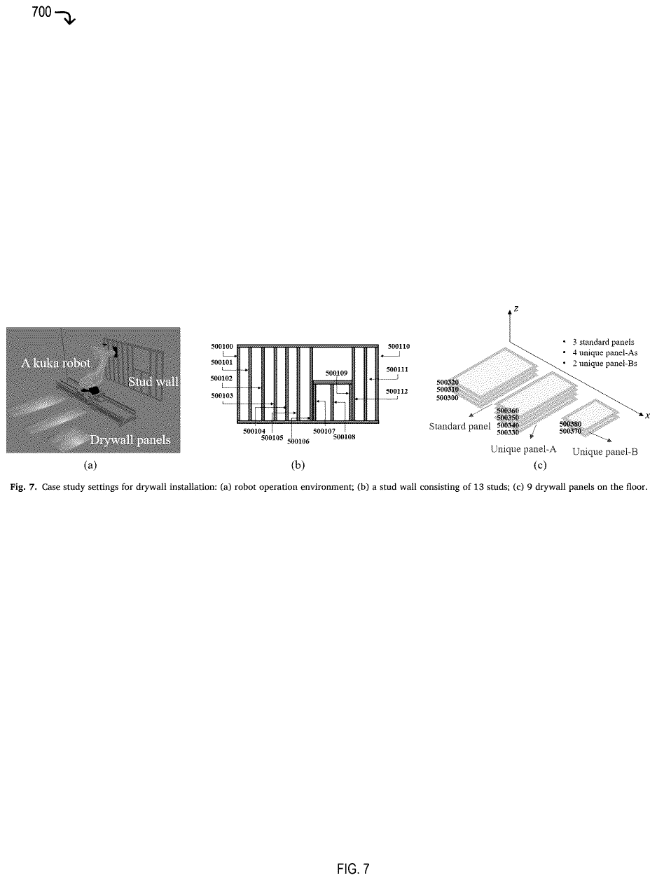

FIG. 7 depicts an exemplary robot operation environment 700 tailored for the installation of drywall panels, showing the interaction between a robot and its surroundings during a construction task. In FIG. 7(a), a KUKA robot, equipped with the necessary actuators and tools for pick-and-place operations, is strategically positioned between a stud wall and an array of drywall panels. The robot's base is capable of moving along a straight line, enabling it to adjust its position relative to the drywall panels and the stud wall for optimal task execution.

The stud wall, as illustrated in FIG. 7(b), comprises thirteen vertical studs. These studs serve as the structural framework to which the drywall panels are attached. For the purpose of this case study, one of these studs is designated as the target location for the placement of a drywall panel. The left edge of the drywall panel is aligned with the stud, demonstrating one of the possible configurations for panel installation.

Drywall panels, typically rectangular in shape, come in standard sizes as well as custom dimensions tailored to specific construction needs. FIG. 7(c) introduces three sizes of panels used in the experiment, including the standard size of 4 ft by 8 ft and two additional sizes cut according to the designed dimensions prevalent in construction practice. This variety in panel sizes illustrates the flexibility and adaptability of the present techniques in handling materials of different dimensions.

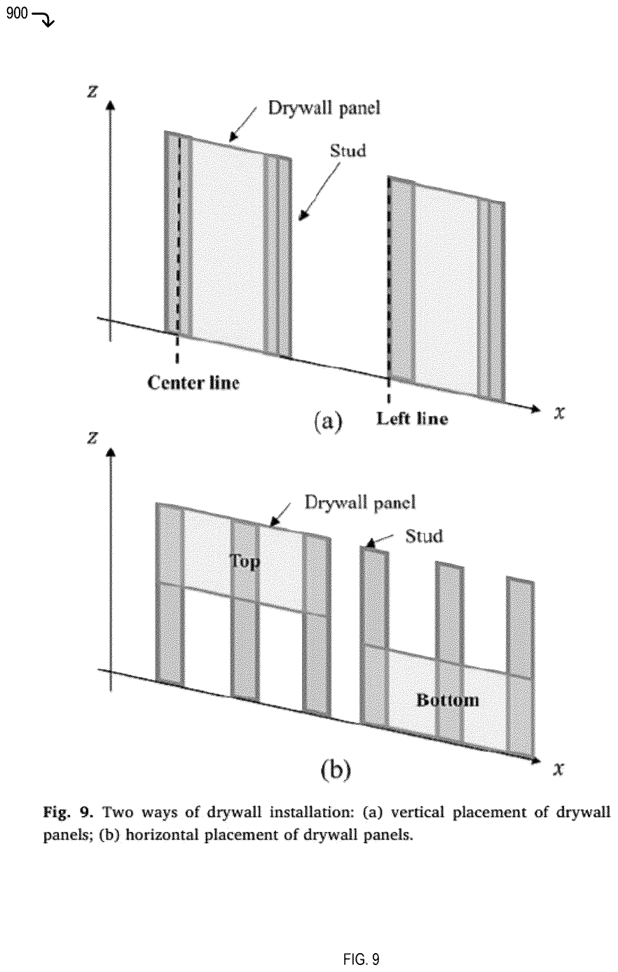

The installation of drywall panels can be executed in either a vertical or horizontal orientation, as further elaborated in the subsequent figures. Vertical placement options, as shown in FIG. 9(a), include aligning the left edge of the panel with the center line of a stud or positioning it on the left side of a stud. Conversely, when installing panels horizontally, perpendicular to the studs, the panels may be placed on either the top or bottom part of the studs, as depicted in FIG. 9(b). This flexibility in placement orientation illustrates the capability of the present techniques to accommodate various installation requirements through natural language instructions that specify the desired configuration for placing the drywall panels.

The interaction between the robot and the construction materials, facilitated by the present techniques, is grounded in a methodical approach that integrates Natural Language Understanding (NLU), Information Mapping (IM), and Robot Control (RC) modules. This approach enables human workers to intuitively communicate with the robot using natural language instructions, directing the robot to perform pick-and-place operations with high accuracy and efficiency. The hardware components, including microphones for speech recognition, computing hardware for NLU, and sensors and cameras for environmental feedback, work in concert to capture, interpret, and execute the natural language instructions provided by human workers. This collaborative ecosystem not only enhances the efficiency and safety of construction work but also exemplifies the potential of human-robot collaboration in addressing the complexities of construction tasks.

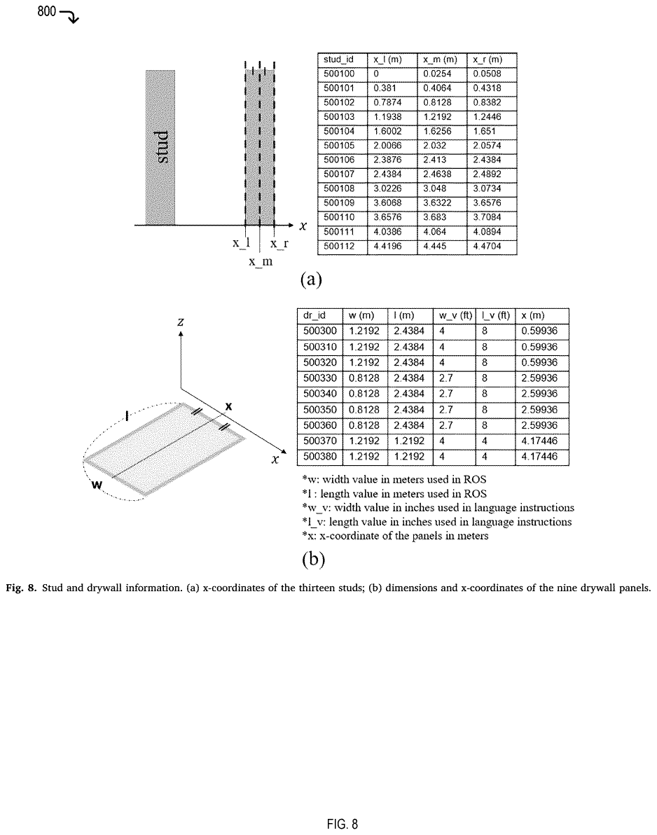

FIG. 8 depicts an exemplary representation of the position and dimension information of building components 800 used in a case study for drywall installation. This figure serves as a reference for understanding the spatial arrangement and specific measurements of the components involved in the construction task, facilitating the accurate execution of tasks by robot assistants based on natural language instructions.

In the context of the present techniques, FIG. 8 illustrates a schematic layout of a construction site, specifically focusing on the arrangement of drywall panels and their corresponding dimensions. The figure could include a variety of drywall panels, each labeled with unique identifiers to distinguish one panel from another. These identifiers may correspond to specific instructions given by human workers, allowing for precise selection and placement of panels by the robot assistants.

The drywall panels depicted in FIG. 8 may vary in size, reflecting common practices in construction where panels are cut to fit the designed dimensions of a structure. Standard sizes, as well as custom-sized panels, could be used in the present techniques to accommodate different construction requirements. The dimensions of each panel, such as width and height, may be included, providing useful data for the Information Mapping (IM) System to process and map natural language instructions to specific tasks.

Additionally, FIG. 8 includes a representation of the construction environment, such as the layout of studs or other structural elements to which the drywall panels are to be attached. This environmental context is vital for the Robot Control (RC) Unit to navigate the construction site and perform tasks accurately. The spatial relationship between the drywall panels and the structural elements illustrates potential placement orientations as dictated by natural language instructions.

The present techniques leverage the detailed information provided in FIG. 8 to enable intuitive interaction between human workers and robotic assistants. By interpreting natural language instructions that reference specific panels and their intended placement, the system can direct robot assistants to perform pick-and-place operations with high precision. The Natural Language Understanding (NLU) module processes the spoken instructions, extracting relevant data such as panel identifiers and placement instructions. This data is then mapped to the physical components and their spatial arrangement as depicted in FIG. 8 by the Information Mapping (IM) System. Finally, the Robot Control (RC) Unit executes the task, guiding the robot assistants to select the correct panels and place them in the specified orientation and location.

Through the integration of hardware components such as microphones for speech recognition, computing hardware for NLU, and sensors and cameras for environmental feedback, the present techniques facilitate a seamless and efficient collaboration between human workers and robot assistants. This collaboration is grounded in the accurate interpretation and execution of natural language instructions.

FIG. 9 depict exemplary methods 900 for placing drywall panels onto studs during construction, illustrating the versatility in orientation and positioning of the panels relative to the studs. This figure is divided into two main parts, (a) and (b), each demonstrating different placement orientations of drywall panels on a stud wall, which is an aspect of the present techniques for human-robot collaboration in construction work.

Part (a) of FIG. 9 shows examples of vertical placement of drywall panels. In this orientation, the left edge of a drywall panel may be aligned with the center line of a stud or positioned to the left side of a stud. This demonstrates the flexibility in positioning that can be specified through natural language instructions, allowing for adjustments based on the specific requirements of the construction project or the dimensions of the space being worked on.

Part (b) of FIG. 9 illustrates the horizontal placement of drywall panels, where the panels are positioned perpendicular to the studs. The panels may be placed either on the top or bottom part of the studs, further indicating the adaptability of the method to various construction needs. This orientation is particularly useful for maximizing the use of space and materials, as well as for accommodating specific design preferences or structural requirements.

The ability to place drywall panels in both vertical and horizontal orientations as shown in FIG. 9 is advantageous and leads to effectiveness of the present techniques in real-world tasks. It allows for a high degree of customization in the construction process, enabling human workers to communicate specific placement instructions to robot assistants using natural language. This flexibility is useful for addressing the diverse and often unpredictable challenges encountered in field construction work.

Moreover, the inclusion of natural language instructions for specifying the orientation and positioning of drywall panels illustrates the intuitive nature of the interaction between human workers and robotic assistants. By using natural language, workers can efficiently convey complex instructions without the need for extensive training in robot programming. This approach not only enhances the efficiency of the construction process but also promotes a more seamless integration of robotic assistants into construction teams.

FIG. 10 depicts an exemplary representation of the detailed categorization of natural language instructions for drywall installation 1000, utilizing a comprehensive set of labels. These labels are designed to capture three useful categories of information: characteristics of the target object, the final location for placement, and the placement orientation. Specifically, a set of these tags are dedicated to describing various attributes of the target object, such as its identification number (ID), dimensions, and position. Another set of tags are employed to elucidate the final location where the target object is to be placed, focusing on the identification and position of the stud. The remaining tags, including one designated as ‘O’ for words not associated with any specific entity, are used to detail the placement orientation, indicating whether the drywall panel is to be installed vertically in the middle, horizontally on the top, or horizontally on the bottom of a stud.

The dataset, generated from a combination of construction videos and academic studies on pick-and-place language instructions, aims to reflect commonly used expressions in drywall installation tasks. It uniquely identifies drywall panels and studs using a combination of ID numbers, dimensions, and relative locations, enhancing the specificity and clarity of the instructions. For instance, a drywall panel might be represented by its unique ID number, tagged as ID_wall, and its dimensions could be labeled with tags such as length, width, or dim. Similarly, the location of a drywall panel or a stud is described using perspective-based tags like St_loc1 and Dw_loc1, with additional tags like St_loc2 and Dw_loc2 used for describing relative positions.

Advantageously, this structured approach to data annotation allows for the precise interpretation of natural language instructions, facilitating the accurate extraction of detailed information necessary for the execution of drywall installation tasks. The tags are designed to capture the nuanced requirements of each instruction, ensuring that the robot can understand and perform the task as intended by the human worker. For example, the default placement method, where a panel is installed vertically on the left line of a stud without explicit mention in the instruction, highlights the system's ability to infer certain actions based on the context, further simplifying the communication process between human workers and robot assistants.

The dataset may include many (e.g., 1584 or more) natural language instructions, which have been manually annotated to ensure the accuracy and consistency of the labels. These instructions are divided into training, validation, and test sets, allowing for the thorough training and evaluation of the Natural Language Understanding (NLU) module. The detailed annotation process, including the division of the dataset and the specific counts of words associated with each tag, illustrates the depth and complexity of the information that the system can handle. This approach to data generation and labeling not only enhances the system's ability to interpret and execute natural language instructions but also sets a foundation for extending these techniques to other pick-and-place construction tasks beyond drywall installation.

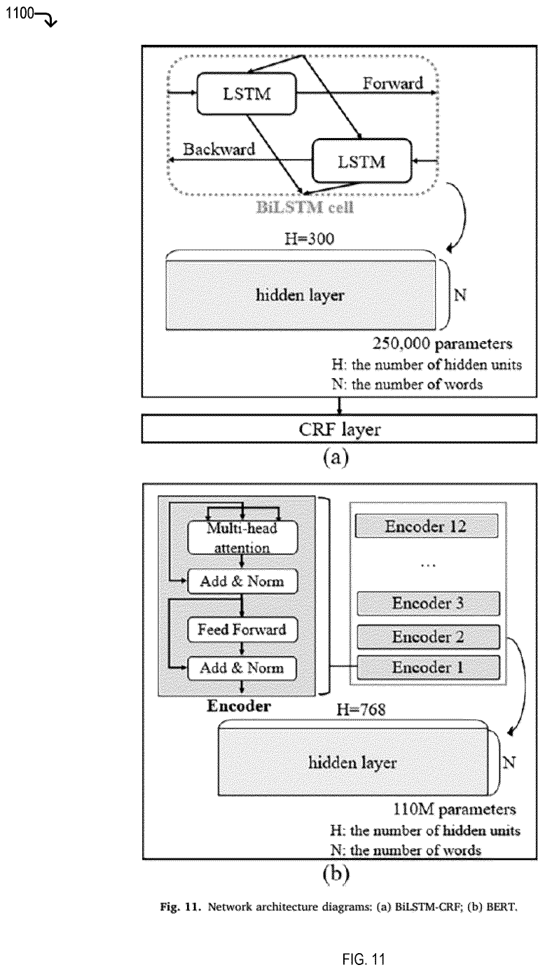

FIG. 11 depicts an exemplary network architecture diagram 1100 for two distinct language models: BiLSTM-CRF and BERT, which are integral to the Natural Language Understanding (NLU) module of the present techniques. These models are designed to process natural language instructions given by human workers for interacting with robotic assistants in field construction work, specifically focusing on pick-and-place operations such as drywall installation.

The BiLSTM-CRF model, as illustrated in part of FIG. 11, may include two neural network layers, with a word embedding size of 50 and 300 hidden layer LSTM neurons, for example. This configuration is chosen to effectively capture the sequential and contextual nature of natural language instructions. The model employs a dropout rate of 0.1 to prevent overfitting and uses the Adam optimizer with a learning rate of 0.001 for training. The BiLSTM-CRF model is trained over 20 epochs, indicating the number of complete passes through the training dataset. This model is particularly adept at handling sequence prediction problems, making it suitable for interpreting the sequential structure of natural language instructions. It should be appreciated that other model parameters may be selected, for performing tasks.

On the other hand, the BERT model, also depicted in FIG. 11, utilizes the “BertForTokenClassification” class to fine-tune the BERT-base-uncased model. This model comprises 12 encoder layers, 12 attention-heads, and 768 hidden units, showing its capacity to process and understand complex language instructions through deep learning techniques. The BERT model is trained with a batch size of 16, a dropout rate of 0.1, and employs the Adam optimizer with a learning rate of 3e−5. It undergoes training for 5 epochs, reflecting its efficiency in learning from the training data. The BERT model's architecture is designed to leverage pre-trained language understanding for a wide range of natural language processing tasks, including the interpretation of construction-related instructions. It should be appreciated that other model parameters may be selected, for performing tasks.

Both models, as part of the NLU module, play a role in the present techniques by analyzing natural language instructions from human workers and extracting relevant information for the subsequent Information Mapping (IM) and Robot Control (RC) modules. These models are trained with varying amounts of data to evaluate the impact of training data size on performance, demonstrating their capability to achieve high accuracy in understanding and processing natural language instructions. The architecture and training parameters of these models are carefully selected based on prior studies and empirical evidence to optimize their performance for the specific application of facilitating intuitive human-robot interaction in construction environments.

Through the deployment of these models within the NLU module, the present techniques enable robotic assistants to accurately interpret and act upon natural language instructions provided by human workers. This approach significantly enhances the efficiency and safety of construction work by using the strengths of both human flexibility and robotic precision in a collaborative setting.

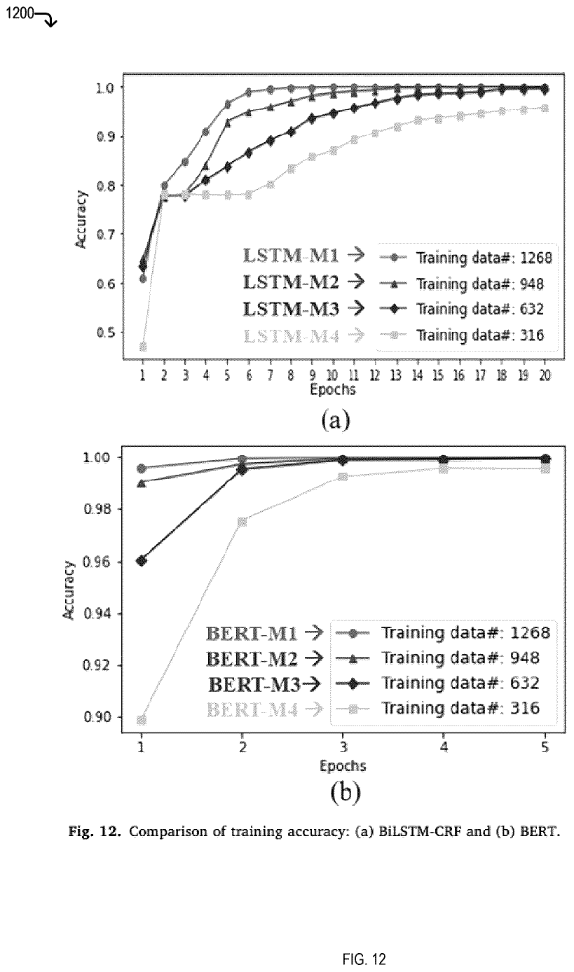

FIG. 12 depicts an exemplary representation 1200 of the performance evaluation of natural language understanding (NLU) models, specifically focusing on the BiLSTM-CRF and BERT models, in the context of interpreting natural language instructions for human-robot collaboration in construction tasks. This figure is divided into two parts, labeled as FIG. 12(a) and FIG. 12(b), each illustrating the training accuracy of the respective models over a series of epochs.

In FIG. 12(a), the graph presents the training accuracy progression of four distinct BiLSTM-CRF models, each trained with varying amounts of data to assess the impact of dataset size on model performance. The x-axis represents the number of training epochs, while the y-axis indicates the accuracy percentage achieved by each model. The models, denoted as LSTM-M1 through LSTM-M4, show a trend where models trained with larger datasets tend to exhibit a quicker and more pronounced improvement in accuracy, especially in the initial phases of training.

Similarly, FIG. 12(b) shows the training accuracy of four BERT models, also labeled from BERT-M1 to BERT-M4, across a shorter span of epochs due to their quicker convergence rate. The same axes apply, with the x-axis detailing the epochs and the y-axis showing the accuracy percentage. The BERT models demonstrate a robust ability to achieve high accuracy levels, with BERT-M1, in particular, reaching near-perfect accuracy. This part of the figure illustrates the effectiveness of fine-tuning pre-trained models like BERT, even when available training data is limited.

Both parts of FIG. 12 collectively highlight the comparative analysis of the BiLSTM-CRF and BERT models in processing natural language instructions for construction-related tasks. The depicted training accuracies provide insights into the models'learning efficiencies and their potential applicability in enhancing human-robot collaboration in the construction industry. The figure emphasizes the importance of dataset size in training NLU models and shows the promising capabilities of advanced models like BERT in understanding complex, task-specific natural language instructions with high precision.

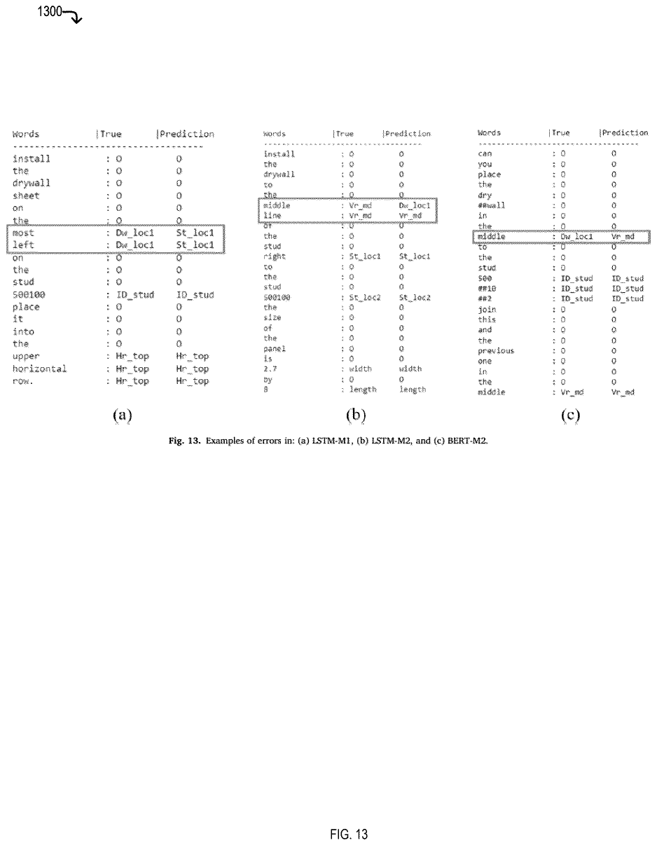

FIG. 13 depicts an exemplary comparison 1300 of the performance of different models in interpreting natural language instructions for construction tasks, specifically focusing on the accuracy of identifying key information within these instructions. The figure illustrates the outcomes of using two distinct machine learning models, the BiLSTM-CRF and BERT, to process and understand instructions given in natural language by human workers to robotic assistants in the context of construction work, such as drywall installation.

In this figure, sub-figure (a) shows an example of an instruction where the BiLSTM-CRF model incorrectly predicts a piece of information, such as misidentifying a location descriptor. This could involve the model interpreting the phrase “most left” as referring to a stud location (St_loc1) instead of the intended drywall panel location (Dw_loc1). This misinterpretation illustrates the challenges faced when models attempt to discern the context and specific details from natural language instructions, which are inherently ambiguous and may use colloquial or site-specific language.

Sub-figure (b) illustrates a similar scenario where the word “middle” is incorrectly classified, demonstrating the nuanced understanding required to accurately process natural language instructions. The word “middle” might be contextually relevant to both a placement method (Vr_md) and a location (Dw_loc1), highlighting the complexity of natural language processing in construction tasks where spatial and orientation details are.

Sub-figure (c) presents an instance from the BERT model's performance, possibly showing how it too can struggle with similar issues as the BiLSTM-CRF model, such as misclassifying the word “middle.” However, the BERT model's overall higher accuracy in processing instructions, as indicated by fewer errors in prediction, suggests its greater effectiveness in understanding the context and specifics of construction-related instructions.

The figure also includes data or visual representations comparing the instruction-level accuracy of the models, illustrating how even a single mispredicted tag in an instruction can significantly impact the ability of a robot to accurately execute a task. This highlights the importance of achieving high accuracy not just at the word level but across entire instructions to ensure that robots can perform tasks correctly based on the natural language commands they receive.

Furthermore, FIG. 13 may visually represent the challenges of training models with limited data, showing how models like LSTM, trained with smaller datasets, exhibit a higher number of incorrect predictions, particularly in critical categories such as location and placement method. This emphasizes the need for robust datasets and effective training to enhance the models'ability to accurately interpret and act on natural language instructions in the dynamic and complex environment of construction sites.

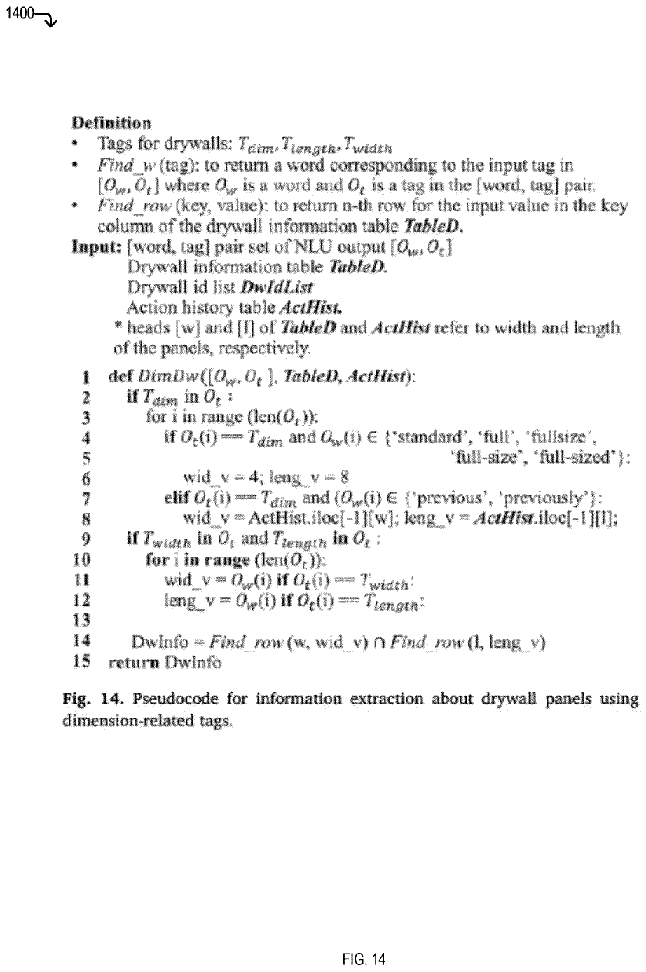

FIG. 14 depicts an exemplary pseudocode 1400 for the Information Mapping (IM) module, specifically tailored for handling scenarios where the target of a pick-and-place operation is described through its dimensions. This figure illustrates the logical flow and decision-making process involved in identifying the target drywall panel based on either explicit length and width values or terms indicative of standard sizes, such as ‘standard’ and ‘full-size’. The process begins by referencing the drywall information table, denoted as TableD, to extract the target features based on the specified dimensions. In instances where the instruction refers to a “previously installed” panel, the module retrieves the last performed operation's target from the action history table, labeled as ActHist. This enables the identification of a panel with matching characteristics as the target for the current operation.

The pseudocode 1400 outlined in FIG. 14 serves as a component of the IM module by providing a structured approach to interpret natural language instructions related to drywall panel dimensions. This interpretation is for accurately mapping these instructions to specific tasks that the robot can understand and execute. By using the information stored in TableD and ActHist, the module efficiently determines the appropriate target panel for the operation, ensuring that the robot's actions align with the human worker's instructions.

This process exemplifies the present techniques'capability to facilitate intuitive and effective human-robot collaboration in construction tasks. By allowing human workers to describe targets using natural language instructions that include dimensions or references to previous operations, the present techniques support a seamless integration of robots into construction workflows. The ability to interpret and act upon such instructions illustrates the potential of the present techniques to enhance productivity and accuracy in construction projects, particularly in tasks requiring precise identification and handling of materials like drywall panels.

Moreover, the pseudocode 1400 in FIG. 14 highlights the adaptability of the IM module to various forms of instruction, accommodating both specific dimensional inputs and more general references to panel sizes or previous installations. This flexibility is useful in bridging the gap between human language and robot actions, making it easier for workers to communicate their needs without requiring extensive knowledge of robot programming. The inclusion of this pseudocode in the overall framework of the present techniques demonstrates a thoughtful approach to designing human-robot interaction systems that are both user-friendly and effective in executing construction tasks.

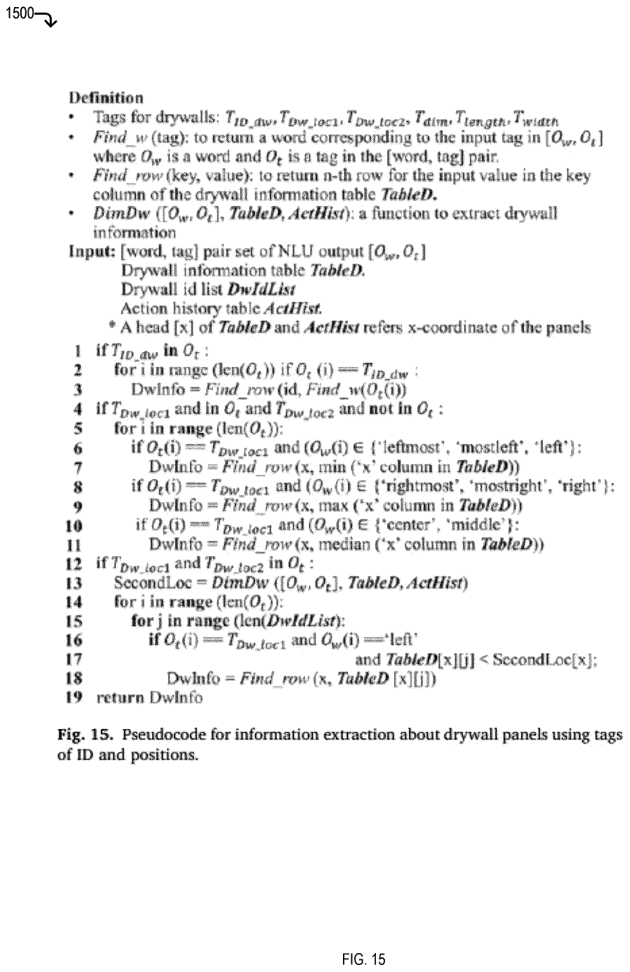

FIG. 15 illustrates pseudocode 1500 for determining the target drywall panel for pick-and-place operations based on identifiers (IDs) or positions as interpreted from natural language instructions. This process is a component of the Information Mapping (IM) module, which bridges the gap between the natural language understanding outputs and the specific commands needed for robot control in construction tasks, such as drywall installation.

The pseudocode 1500 begins by checking if the output from the Natural Language Understanding (NLU) module includes a tag labeled as ID_wall. If this tag is present, it signifies that the natural language instruction specified a particular drywall panel by its unique identifier. The system then retrieves the corresponding panel information, including its dimensions and location, based on this ID from a predefined database or table of drywall panels.

In scenarios where the instruction does not specify an ID but mentions a location (Dw_loc1), the pseudocode 1500 outlines a method to determine the target panel based on its initial position. The x coordinate value for the initial position of drywall panels, along with a word tag associated with Dw_loc1, is used to identify the target panel. This approach allows for the selection of a panel based on its relative location within the construction site or storage area.

Furthermore, if the instruction includes references to two locations (Dw_loc1 and Dw_loc2), the target panel is identified based on its relative position to these locations. The pseudocode specifies that the x coordinate of the target panel's initial position is determined by considering the secondary location and the direction tagged with Dw_loc2 and Dw_loc1, respectively. This method enables the system to accurately interpret instructions that describe the target panel in relation to other objects or landmarks at the construction site.

The process outlined in FIG. 15 is useful for enabling robots to accurately identify and select the correct drywall panel for installation tasks based on natural language instructions. By using identifiers and positional information, the IM module can effectively translate human instructions into specific, actionable commands for the robot assistants. This approach facilitates intuitive and efficient human-robot collaboration in construction tasks, allowing human workers to communicate task requirements to robots in a manner that mimics human-to-human interaction. Through this method, the present techniques aim to enhance productivity and safety in construction work by using the strengths of both human workers and robotic assistants.

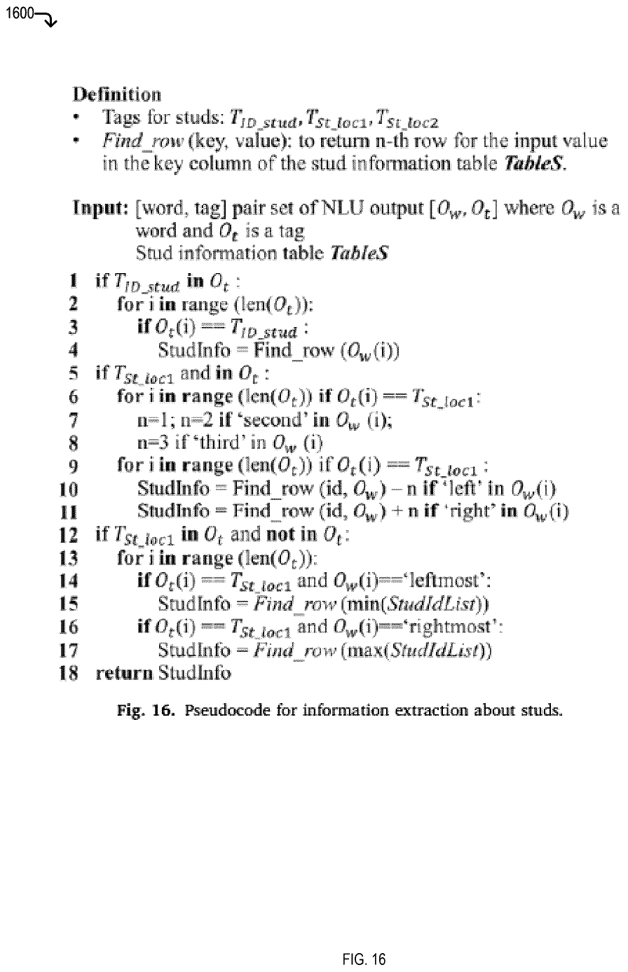

FIG. 16 illustrates the process 1600 for extracting information regarding a stud, which serves as the final location for pick-and-place operations in construction tasks, such as drywall installation. This figure is part of a broader framework designed to facilitate natural language interaction between human workers and robotic assistants in the field of construction. The framework aims to enable human workers to communicate instructions to robots using natural language, thereby enhancing efficiency and safety on construction sites.

In the context of the Information Mapping (IM) module, FIG. 16 details a method for identifying the specific stud where a drywall panel or other construction material is to be placed based on the output from the Natural Language Understanding (NLU) module. The NLU module interprets the natural language instructions provided by human workers and extracts relevant tags that describe the task at hand.

When the output of the NLU module includes the tag ID_stud, the method retrieves information about the specific stud corresponding to that ID. This information may include the stud's location, dimensions, and other relevant attributes necessary for the robot to accurately place the construction material.

If the output from the NLU module does not contain the ID_stud tag but includes tags such as St_loc1 or St_loc2, the method determines the stud's location based on these tags. The location of the stud is described in terms of its spatial relationship to other elements on the construction site. For instance, if only St_loc1 is present in the NLU output, the method may interpret the stud as being the leftmost or rightmost one in a given area, depending on the context provided by the natural language instructions.

In scenarios where both St_loc1 and St_loc2 tags are extracted from the NLU output, the final location of the stud is determined by analyzing the spatial relationship described by the words associated with these tags. This approach allows for a more precise identification of the stud's location based on relative positioning, such as “next to the window” or “between studs A and B.”

The method depicted in FIG. 16 plays a role in the overall framework for human-robot collaboration in construction. By accurately identifying the final location for pick-and-place operations, the robot can execute tasks with a high degree of precision, thereby replicating the nuanced instructions typically given by human workers in a construction setting.

Furthermore, the process 1600 outlined in FIG. 16 contributes to the system's ability to facilitate intuitive and natural interaction between human workers and robotic assistants. By using natural language instructions, the system advantageously reduces or altogether eliminates the need for specialized training or technical knowledge on the part of human workers, making it easier for them to collaborate with robots in completing construction tasks.

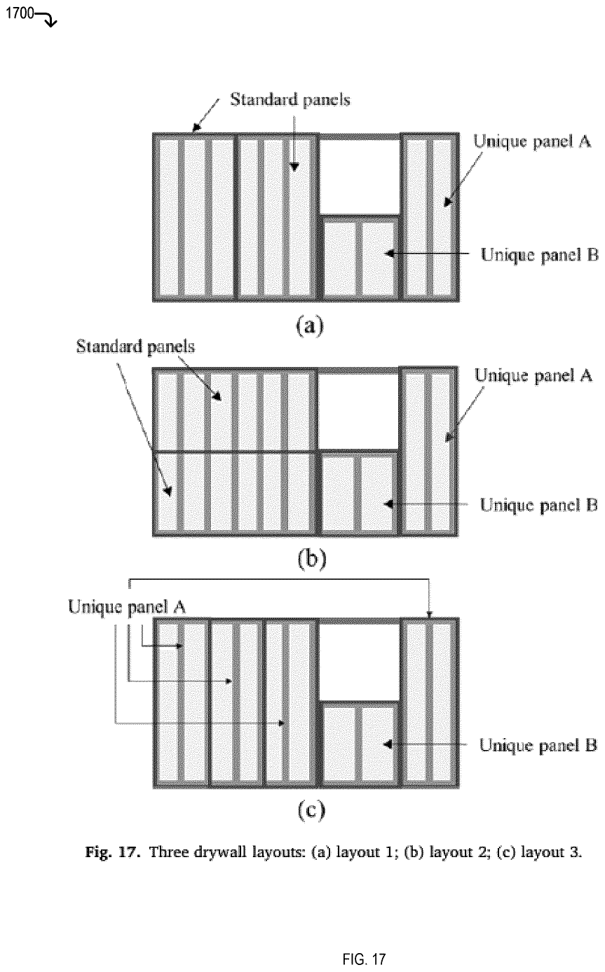

FIG. 17 depicts an exemplary block diagram 1700 of drywall installation using three distinct layouts, showing the versatility and effectiveness of the present techniques in interpreting and executing natural language instructions for construction tasks. This figure illustrates how the combination of Natural Language Understanding (NLU) and Information Mapping (IM) modules can facilitate intuitive human-robot collaboration (HRC) in the field of construction, specifically in the context of drywall installation.

In the layouts presented in FIG. 17(a) and FIG. 17(b), the block diagram 1700 utilizes one unique panel A and one unique panel B, alongside two standard panels. These panels are installed in two orientations: vertically in FIG. 17(a) and horizontally in FIG. 17(b). This variation in panel orientation demonstrates the system's capability to accurately interpret and execute instructions pertaining to different installation methods based on natural language inputs. The layout in FIG. 17(c) further extends this demonstration by placing two types of distinct panels vertically, showing the system's adaptability to handle instructions for various drywall panel types and orientations.

The input data for the NLU module, selected from a test dataset, underpins the successful execution of these layouts. The NLU module's role is to accurately understand the natural language instructions given by human workers, translating these instructions into a format that can be processed by the system. Following this, the IM module maps the interpreted instructions to specific tasks and sequences that the robot assistants can understand and execute. This process ensures that the robot assistants carry out the tasks as intended, based on the natural language instructions provided.

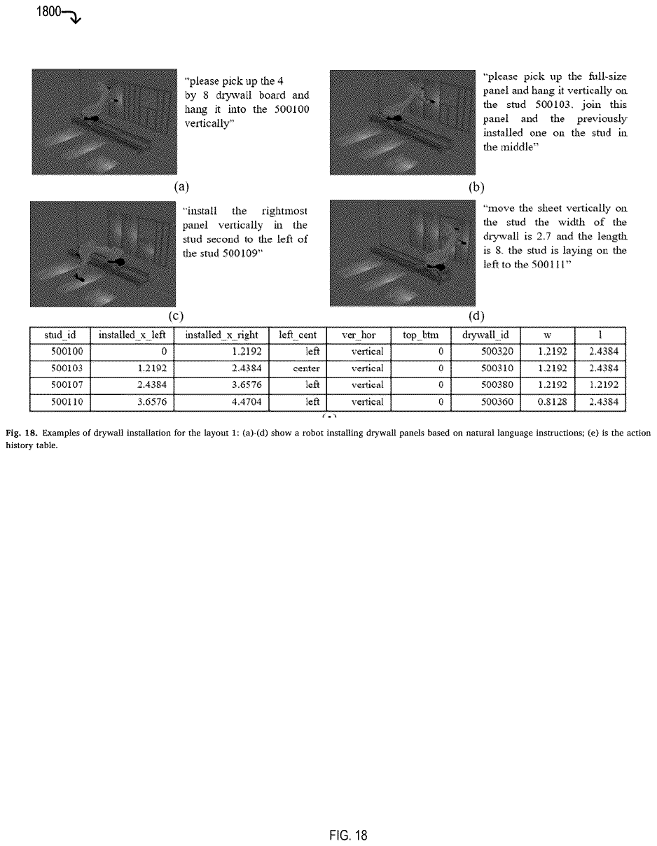

The demonstration results for layout 1, as detailed in subsequent figures (e.g., FIG. 18), highlight the precise execution of drywall installation tasks by the robot assistants, corresponding to the layouts of the block diagram 1700 in FIG. 17. For instance, the installation of a drywall panel at a specific location and orientation, as determined by the IM module in response to the natural language instruction, exemplifies the system's high level of accuracy and efficiency. The action history table associated with these results further illustrates the system's capability to track and document the execution of tasks, providing a clear record of the robot's actions in response to the instructions.

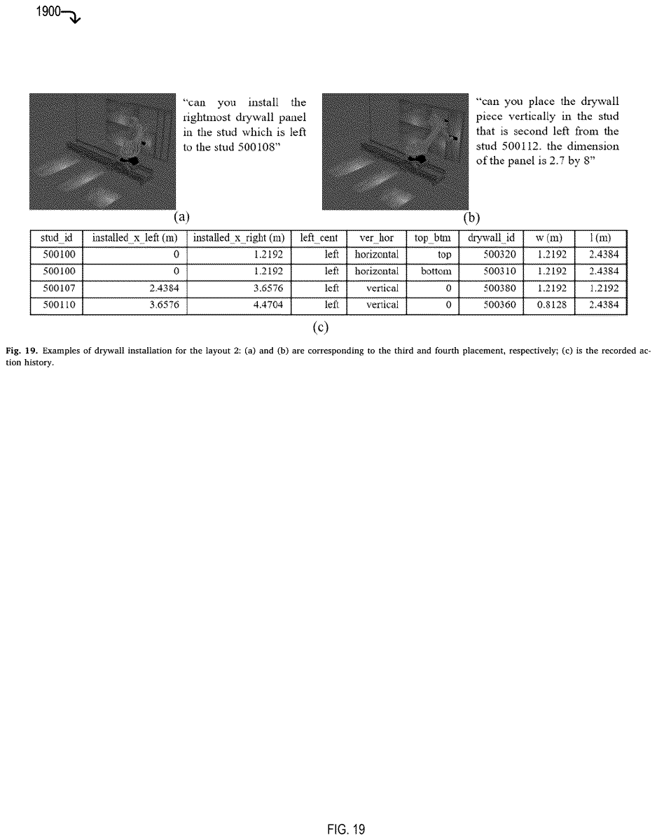

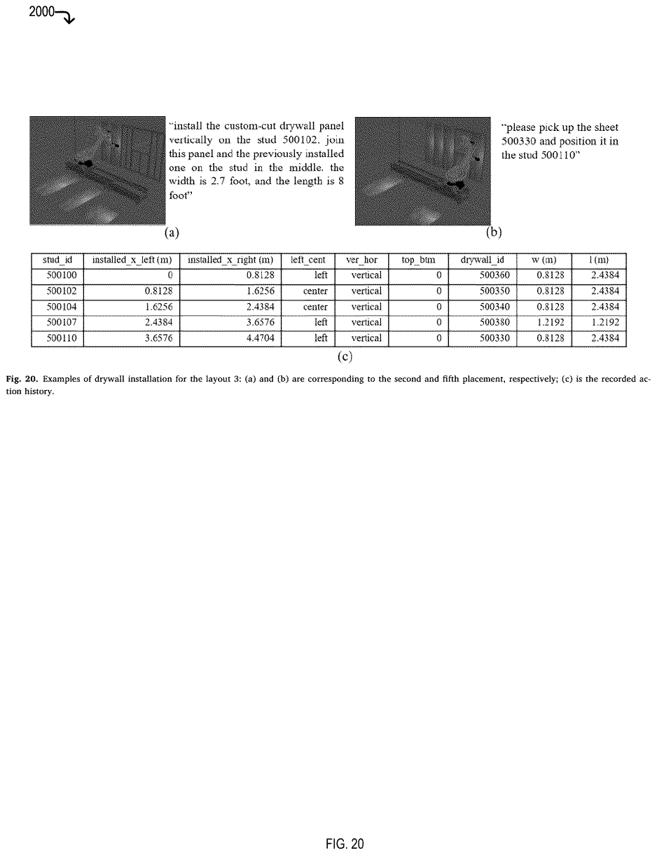

FIGS. 19 and 20, which detail the natural language instructions and demonstration results for layouts 2 and 3 of FIG. 17, respectively, reinforce the effectiveness of the present techniques in facilitating natural and intuitive interaction between human workers and robot assistants. The successful installation of drywall panels in these layouts, guided by the accurate extraction of information from the NLU and IM modules, illustrates the potential of natural language-based interaction to enhance productivity and safety in construction work. FIG. 17 and the associated demonstration results illustrate the significant potential of using natural language-based interaction to facilitate human-like communication in human-robot teams within the construction domain. By enabling human workers to intuitively interact with robot assistants using natural language instructions, the present techniques represent a substantial advancement in the field of Human-Robot Collaboration (HRC), particularly in addressing the complexities and uncertainties inherent in construction work.

FIG. 18 depicts an exemplary environmental diagram 1800 of a robot performing drywall installation tasks based on natural language instructions processed through a Natural Language Understanding (NLU) module and an Information Mapping (IM) module. This figure illustrates the practical application of the present techniques in a construction setting, specifically showing how a robot, such as a KUKA robot, can accurately place drywall panels onto studs as instructed through natural language commands by human workers.

The figure is divided into several parts, each corresponding to a different set of instructions and outcomes. In one part of FIG. 18, it may show the robot successfully placing a drywall panel, identified as “drywall panel 500,320,” onto a specific location on a stud, referred to as “stud 500,100.” This action is based on the interpretation of the natural language instruction that directs the panel to be installed perpendicular to the left line of the stud. The corresponding action history table may record this result, indicating the successful execution of the task as per the processed instructions.

Another part of FIG. 18 illustrates the robot installing a drywall panel vertically on the center line of a stud. This action could be the result of the NLU module predicting a vertical middle placement (“Vr_md”) from the natural language instruction provided. The action history table may again reflect this outcome, showing the robot's ability to understand and execute the task based on the natural language input and the information mapping process.

Further, FIG. 18 could include instances where the robot places drywall panels in specific locations relative to the studs, such as “second to the left” or directly “left,” as interpreted from the natural language instructions. These locations, tagged as “St_loc1” and “St_loc2” in the NLU module, demonstrate the system's capability to accurately process spatial instructions and translate them into precise robotic actions. The IM module, through its predefined rules, may determine the exact studs, such as “stud 500,107” and “stud 500,110,” as the final locations for the installation tasks. The action history table may provide a detailed account of these outcomes, highlighting the effectiveness of the present techniques in facilitating natural language-based interaction between human workers and robot assistants in construction tasks.

FIG. 18 serves as a concrete example of how the present techniques enable a robot to perform drywall installation tasks with high accuracy and efficiency, based on natural language instructions. It illustrates the potential of human-robot collaboration in construction work, where the flexibility and intelligence of human workers are complemented by the physical capabilities and precision of robot assistants. Through the integration of NLU and IM modules, the present techniques facilitate intuitive and natural interaction between humans and robots, making advanced construction tasks more accessible and manageable.

FIG. 19 illustrates the application 1900 of the present techniques in executing drywall installation tasks for a second layout, as informed by natural language instructions. This figure, alongside FIG. 20, shows the effectiveness of the present techniques in translating human instructions into robotic actions for different drywall panel arrangements. In the context of FIG. 19, the robot assistants perform pick-and-place operations based on the processed instructions, demonstrating the adaptability of the present techniques to various layout configurations.

The process begins with human workers providing natural language instructions, which are captured by microphones or speech recognition hardware, for example worn by the speaker, installed in the workspace (e.g., via a boom stand or hanger) and/or installed on the robot. These instructions may involve specific details about the placement of drywall panels in relation to the construction site's framework, such as studs. The captured speech is then processed by the computing hardware dedicated to Natural Language Understanding (NLU). The NLU module interprets the instructions, identifying key components such as the target drywall panel, its intended location, and the orientation for placement. The NLU module may be trained to recognize one or more natural languages (e.g., English, Spanish, French, German, etc.).

Following the interpretation of instructions, the Information Mapping (IM) system may take the output from the NLU module and map it onto specific tasks that the robot assistants can understand and execute. This involves determining the exact position where a drywall panel should be placed and the orientation it should have in relation to the studs. The IM system may utilize data from building component information, such as the dimensions and positions of studs, to accurately map the instructions to robotic actions.

The Robot Control (RC) unit then receives the mapped instructions and translates them into commands for the robot assistants. These commands direct the robots to pick up the specified drywall panels and place them at the designated locations on the construction site. The robot assistants, equipped with actuators and tools necessary for construction tasks, execute these commands with precision. Sensors and cameras may provide feedback to the system, ensuring the tasks are performed accurately and adjustments are made as needed.

Throughout this process, a communication network hardware facilitates real-time data exchange and coordination between the human workers, the NLU, IM, and RC systems, and the robot assistants. This network may include one or more wired devices (e.g., one or more routers, switches, computers, etc.), one or more wireless devices (e.g., a mesh network, a wireless router, a network extender, a mobile computing device, a cellular device, a satellite internet controller, etc.). This electronic network may include one or more private and/or public networks (e.g., the internet). This ensures that instructions are processed efficiently and the robots'actions are closely aligned with the workers'intentions. Additionally, user interface devices may be available for human workers to monitor the robots'activities, receive feedback, or provide supplementary instructions if necessary.

FIG. 19, therefore, exemplifies how the present techniques enable intuitive interaction between human workers and robotic assistants in field construction work. By using natural language instructions, the present techniques facilitate a seamless integration of human flexibility and robot precision in performing construction tasks, such as drywall installation, enhancing efficiency and safety on construction sites.

FIG. 20 depicts an exemplary demonstration 2000 of the interaction between human workers and robotic assistants in the context of drywall installation, specifically focusing on layout 3 as introduced in the case study. This figure illustrates the successful application of natural language instructions for directing robotic actions in construction tasks, showing the practical implementation of the proposed method for human-robot collaboration (HRC) in field construction work.

In the scenario depicted in FIG. 20, a robotic assistant, such as a KUKA robot, performs pick-and-place operations based on instructions processed through the Natural Language Understanding (NLU) module and the Information Mapping (IM) module. The figure demonstrates how the robot accurately interprets and executes tasks from a set of natural language instructions provided by human workers. These instructions are designed to mimic the typical human-to-human communication found in construction settings, thereby enabling intuitive interaction between human workers and robotic assistants.

The robotic assistant may include various hardware components such as actuators and tools necessary for handling and installing drywall panels. The robot's actions are guided by the outputs of the NLU and IM modules, which process the natural language instructions into actionable commands. The NLU module is responsible for understanding the content of the instructions, including identifying specific tasks, target objects, and desired locations. The IM module then maps this information onto the physical environment, determining the precise actions the robot needs to take to accomplish the instructed tasks.

FIG. 20 also highlights the role of sensors and cameras in providing feedback about the environment and the status of the tasks being performed. These components may assist the robot in navigating the construction site and ensuring the accurate placement of drywall panels as per the instructions. Additionally, communication network hardware facilitates real-time data exchange and coordination between the human workers, the NLU, IM, and Robot Control (RC) systems, and the robotic assistants, ensuring seamless integration of actions and responses.

The demonstration 2000 results shown in FIG. 20 illustrate the effectiveness of the proposed method in enabling a robot to perform pick-and-place operations with high accuracy, based on natural language instructions. This approach not only leverages the physical capabilities of robotic assistants but also capitalizes on the flexibility and intuitive communication skills of human workers. By employing natural language as the primary mode of interaction, the present techniques significantly enhance efficiency and safety in construction work, making the introduction of robots into complex work domains more feasible and productive.

Overall, FIG. 20 serves as a compelling illustration of the potential of natural language-based interaction to replicate human-like communication in human-robot teams, particularly in the challenging and dynamic environment of construction work. It shows the successful application of the developed method in a specific case study for drywall installation, highlighting the accuracy and reliability of the system in interpreting and executing natural language instructions for construction tasks.

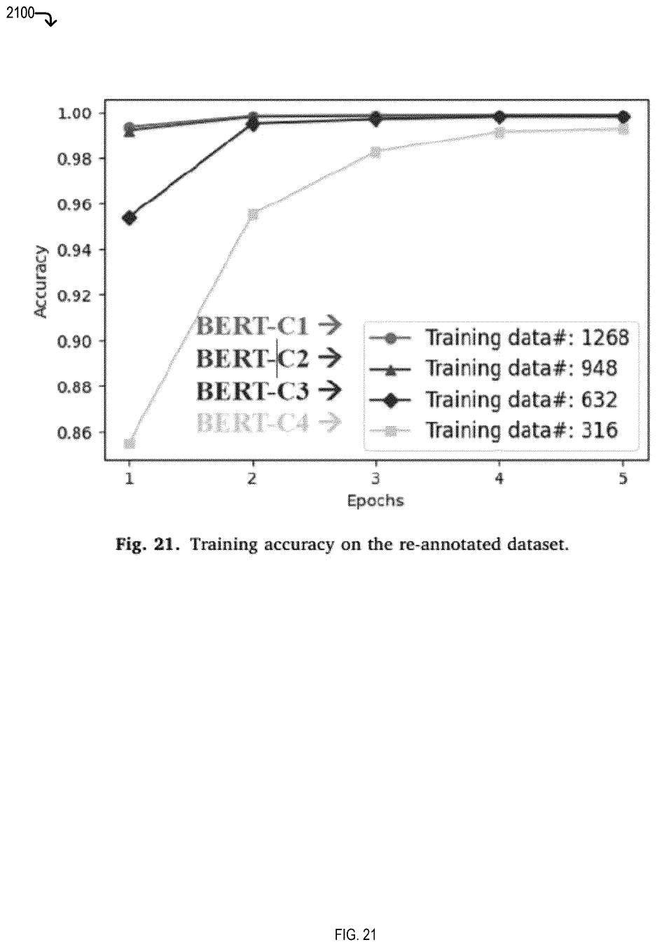

FIG. 21 depicts an exemplary graphical representation 2100 of the training accuracy for datasets that have been re-annotated to address co-reference issues in natural language instructions for human-robot collaboration in construction tasks. The datasets include instructions that have been specifically labeled with two additional tags: Trg (target) and Dst (destination), to enhance the clarity of the instructions for the robot assistants. These labels aim to clearly identify the objects of interest (targets) and their intended final locations (destinations) within the instructions, such as “wall panel” and “stud” in the provided example. The figure illustrates the training accuracy of BERT models, designated as BERT-C (considering co-reference issues) and BERT-M (not considering co-reference issues), across different volumes of training data, specifically for 316, 632, 948, and 1268 instructions.

The training accuracy is tracked over several epochs, with epoch 1 showing a lower accuracy for BERT-C models compared to BERT-M models. However, as the training progresses, by epoch 5, the accuracy of both BERT-C and BERT-M models converges, indicating that the models adapt and learn from the training data over time. This convergence suggests that, despite the initial differences, both sets of models are capable of achieving similar levels of understanding of the natural language instructions when provided with sufficient training data.

The figure further highlights the impact of addressing co-reference issues in the training process. While the BERT-C models, which incorporate co-reference considerations, initially display slightly lower performance compared to their BERT-M counterparts, they achieve comparable accuracy levels with an increase in the volume of training data. This observation suggests that co-reference issues, while potentially impacting initial model performance, can be effectively mitigated through the use of larger training datasets. The models trained with co-reference considerations (BERT-C1 and BERT-C2) demonstrate the potential to reach accuracy levels close to 100% with sufficient data, underscoring the effectiveness of the re-annotation strategy in enhancing model performance.

### Exemplary Computing Environment

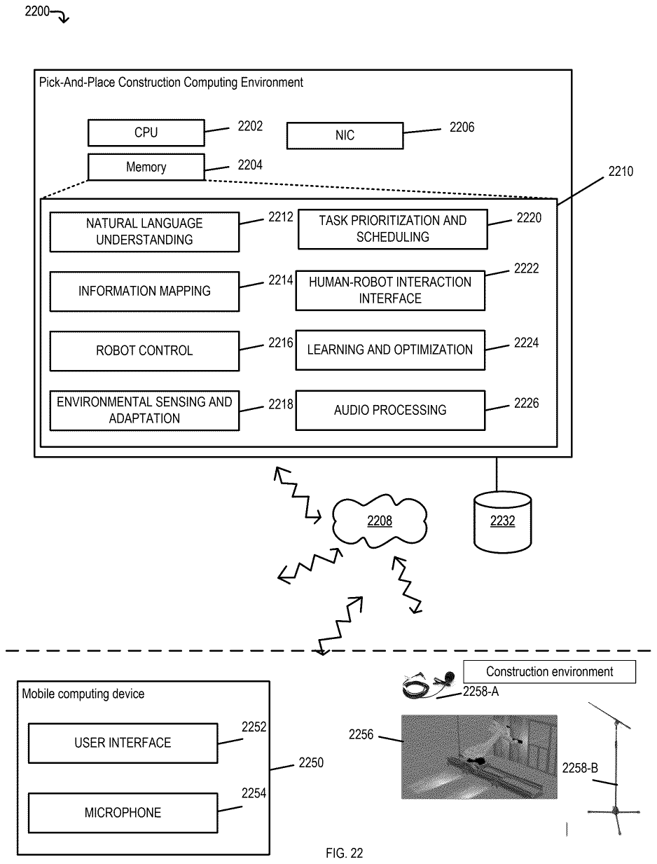

FIG. 22 describes a computing environment 2200 for facilitating intuitive human-robot collaboration in construction work using natural language instructions. The computing environment 2200 may correspond to the environment of FIG. 1, in some aspects. This computing environment, labeled as 2200, includes a central processing unit (CPU) 2202, a memory 2204, and a network interface controller (NIC) 2206. The computing environment 2200 is designed to enable human workers to interact with robot assistants in field construction work, such as drywall installation, through natural language instructions. This interaction aims to combine the flexibility of human workers with the physical abilities of robot assistants to address the uncertainties inherent in construction work effectively.

The CPU 2202 in the computing environment 2200 may include any number of processors and/or processor types, such as CPUs, graphics processing units (GPUs), field-programmable gate arrays (FPGAs), application-specific integrated circuits (ASICs), digital signal processors (DSPs), neural processing units, RISC-V processors, coprocessors, specialized processors/accelerators for artificial intelligence (AI) or machine learning (ML)-specific applications, one or more microcontrollers, and the like. Generally, the CPU 2202 is configured to execute software instructions stored in the memory 2204. The memory 2204 may include volatile and/or non-volatile fixed and/or removable memory, such as read-only memory (ROM), electronic programmable read-only memory (EPROM), random access memory (RAM), erasable electronic programmable read-only memory (EEPROM), and/or other hard drives, flash memory, solid-state drives, optical drives, MicroSD cards, and others. The memory 2204 has stored thereon one or more sets of computer-executable instructions. The memory 2204 within the computing environment 2200 is equipped with non-transitory computer-readable instructions that cause the operation of the system to occur. These instructions are stored on the memory in a manner that allows them to be retained over time, without the need for continuous power or refresh cycles. This non-transitory nature of the storage means that the instructions remain accessible and executable by the CPU 2202, even after the computing environment has been powered down or restarted. The non-transitory computer-readable instructions encompass the software and algorithms that drive the various modules 2210 of the computing environment, including but not limited to a natural language understanding module 2212 (e.g., the NLU module 102-A of FIG. 1), an information mapping module 2214 (e.g., the IM module 102-B of FIG. 1), a robot control module 2216 9 e.g., the RC module 102-C of FIG. 1), and other specialized modules such as an environmental sensing and adaptation module 2218, a task prioritization and scheduling module 2220, a human-robot interaction interface module 2222, a learning and optimization module 2224, and an audio processing module 2226. These instructions enable the system to process natural language instructions from human workers, map these instructions to specific construction tasks, generate control signals for robot assistants, and adapt to changing environmental conditions, among other functionalities. By storing these instructions on non-transitory computer-readable media, the computing environment ensures that the system's core functionalities are preserved and can be reliably executed over time. This approach provides a stable foundation for the computing environment to facilitate effective and efficient human-robot collaboration in construction work, leveraging the advanced capabilities of the system to enhance productivity, safety, and adaptability in various construction scenarios.

The NIC 2206 includes any suitable network interface controller(s), such as wired/wireless controllers (e.g., Ethernet controllers), and facilitates bidirectional/multiplexed networking over the network between the computing environment 2200 and robot assistants. The network may be a single communication network or may include multiple communication networks of one or more types (e.g., one or more wired and/or wireless local area networks (LANs), and/or one or more wired and/or wireless wide area networks (WANs) such as the Internet), as discussed above.

In some aspects, the memory 2204 includes the plurality of modules 2210, each being a respective set of computer-executable instructions. These modules include the natural language understanding module 2212, the information mapping module 2214, and the robot control module 2216. The natural language understanding module 2212 processes received natural language instructions from a human worker to extract task-specific information. The natural language understanding module 2212 processes received natural language instructions from a human worker to extract task-specific information. The natural language understanding module 2212 employs advanced natural language processing techniques to accurately interpret the instructions, identifying key components such as the task to be performed, the target object, and the desired location or orientation for the task. By achieving a high level of accuracy in understanding and interpreting the natural language instructions, this module ensures that the robot assistant accurately comprehends the tasks it is instructed to perform, thereby minimizing errors in task execution.

The information mapping module 2214 takes the task-specific information extracted by the natural language understanding module and maps it to specific construction tasks and sequences that the robot can understand and execute. This module translates the interpreted instructions into a format that is actionable by the robot assistant, considering the unique characteristics of the construction site and task requirements. It employs conditional statements to address any discrepancies between the outputs of the natural language understanding module and the building component information, ensuring that the robot assistant is provided with clear and comprehensive instructions for the task at hand.

The robot control module 2216 generates control signals for the robot assistant to execute the mapped construction tasks based on the natural language instructions. This module converts the mapped tasks and sequences into specific commands that control the robot assistant's movements and actions, enabling it to perform the construction tasks as instructed by the human worker. Through precise control signals, the robot assistant can accurately execute tasks such as picking and placing materials or assembling components, facilitating a seamless collaboration between the human worker and the robot assistant and enhancing productivity and efficiency in construction work.

In some aspects, the modules 2210 may further include the environmental sensing and adaptation module 2218, that may collect and process data from various sensors deployed around the construction site. It monitors environmental conditions, such as temperature, humidity, and the presence of obstacles, to adapt the robot's actions in real-time. For example, if the module detects unexpected debris in the robot's path, it can reroute the robot or adjust its task sequence to ensure safety and task continuity. This module enables the robot to navigate and operate effectively in the dynamic and often unpredictable construction environment.

The modules 2210 may include the task prioritization and scheduling module 2220 that may optimize the workflow on a construction site. For example, the task prioritization and scheduling module 2220 may include computer-executable instructions that analyze a queue of tasks assigned to the robot assistant and prioritizes them based on urgency, dependencies, and the current state of the construction project. It may schedule tasks in a manner that maximizes efficiency and minimizes downtime. For instance, if drywall installation and painting are queued tasks, and the painting area depends on the drywall installation, this module ensures that the drywall task is prioritized and completed first.

The modules 2210 may include the human-robot interaction interface module 2222 that enhances the interaction between human workers and the robot assistant by providing a user-friendly interface for task communication and feedback. The human-robot interaction interface module 2222 may include voice recognition capabilities for hands-free operation and visual displays or augmented reality (AR) overlays to show task progress, robot status, and alerts. This module makes it easier for workers to monitor and interact with the robot, allowing human workers to monitor the activities of the robot, receive feedback, and/or provide supplementary instructions if necessary, even without in-depth knowledge of robotics or programming.

The modules 2210 may include the learning and optimization module 2224 that includes computer-executable instructions implementing machine learning algorithms for training and/or operation of one or more models. The learning and optimization module 2224 may analyze data from completed tasks to improve the efficiency and effectiveness of the robot's operations over time. The learning and optimization module 2224 may identify patterns and optimizations in task execution, path planning, and human-robot interactions, applying these insights to refine the robot's performance. The learning and optimization module 2224 may ensure that the system evolves and adapts to the construction environment, learning from past experiences to enhance future operations.

The computing environment 2200 incorporates machine learning techniques, particularly within the learning and optimization module 2224, to continuously enhance the efficiency and effectiveness of robot operations in construction tasks. A significant aspect of this module's functionality involves the use of Bidirectional Encoder Representations from Transformers (BERT) and Bidirectional Long Short-Term Memory (BiLSTM) models, which are instrumental in processing and understanding natural language instructions and optimizing task execution strategies based on historical data. As discussed above, the BERT is trained herein to understand the context of words in text by considering the words that come before and after, and is utilized within the natural language understanding module 2212. This model processes the natural language instructions received from human workers, accurately interpreting complex commands and extracting task-specific information. The BERT model's deep learning capabilities allow it to grasp the nuances of construction-related terminology and instructions, ensuring that the robot assistants receive clear and actionable tasks. The BiLSTM model is employed to enhance the system's ability to predict sequences of actions and understand the temporal dependencies between tasks in construction projects. This model is particularly useful in the information mapping module 2214, where it aids in translating the interpreted instructions into specific construction tasks and sequences. By analyzing the order and dependencies of tasks, the BiLSTM model helps in optimizing the workflow, ensuring that tasks are executed in the most efficient manner possible. The learning and optimization module 2224 may use these machine learning models to analyze data from completed tasks, identifying patterns and areas for improvement. For instance, by examining past instances of drywall installation, painting or other construction tasks, the module can determine more efficient methods for task execution, such as optimal paths for robot movement or strategies for material handling. These insights are then applied to refine the robot's performance, enabling the system to adapt and evolve based on real-world experiences. Furthermore, the integration of BERT and BiLSTM models within the computing environment facilitates a dynamic learning process, where the system not only becomes more efficient over time but also more adept at understanding and responding to natural language instructions. This continuous learning and optimization process, underpinned by advanced machine learning techniques, significantly enhances the capabilities of the computing environment, enabling it to support a wide range of construction tasks with increasing effectiveness and precision.

The integration of advanced machine learning models such as BERT and BiLSTM, along with the structured modular approach within the computing environment 2200, constitute a significant improvement to computer and computing technology, especially in the context of construction work. These improvements are manifested in several key areas, including enhanced NLP techniques. Specifically, the use of BERT within the natural language understanding module 2212 enables the system to process and interpret natural language instructions with a high degree of accuracy and contextual understanding. This represents a substantial improvement over traditional NLP methods, which may struggle with the complexity and specificity of construction-related language. By accurately interpreting instructions, the system ensures that robots can execute tasks precisely as intended by human workers, reducing errors and improving efficiency. These techniques also provide for optimized task sequencing and execution. Specifically, the application of the BiLSTM model in the information mapping module 2214 allows for a sophisticated understanding of the sequence and dependencies of construction tasks. This capability enables the system to optimize the order in which tasks are executed, taking into account factors such as task urgency, dependencies, and the current state of the construction project. This optimization leads to more efficient use of resources and time, directly contributing to the productivity of construction projects. Further, the present techniques provide adaptive and responsive operations. The modular structure of the computing environment, including the environmental sensing and adaptation module 2218 and the learning and optimization module 2224, allows the system to adapt to changing conditions and learn from past experiences. This adaptability is crucial in the dynamic construction environment, where unforeseen challenges can arise. The system's ability to adjust robot operations in real-time and apply learned optimizations to future tasks represents a significant advancement in making robotic assistance more practical and effective in construction settings. The inclusion of modules such as the human-robot interaction interface module 2222 and the audio processing module 2226 enhances the way human workers interact with robot assistants. These modules facilitate intuitive and efficient communication, allowing workers to easily monitor, control, and adjust robot tasks. This improvement in human-robot collaboration makes advanced robotics more accessible to construction workers, regardless of their technical expertise, and enhances the overall safety and productivity of construction sites. The computing environment's 2200 use of machine learning for ongoing optimization represents a forward-thinking approach to improving computing technology. By analyzing data from completed tasks and applying insights to refine operations, the system embodies a model of continuous improvement. This not only enhances the performance of robot assistants over time but also contributes to the development of smarter, more efficient construction technologies.

The modules 2210 may include the audio processing module 2226. The audio processing module 2226 is specifically designed to capture and process audio signals in the construction environment. It includes advanced sound receiving hardware capable of filtering and distinguishing relevant audio inputs, such as human voice commands, amidst the background noise typical of construction sites. The audio processing module 2226 may receive audio signals from microphones worn by the human worker, installed in the workspace via a boom stand or hanger, and/or installed on the robot assistant. The audio processing component of this module utilizes sophisticated algorithms to analyze the captured sound, extracting clear voice commands and converting them into a digital format that can be understood by the natural language understanding module 2212. This module ensures that voice commands issued by human workers are accurately captured and interpreted, regardless of ambient noise levels. It enables workers to communicate effectively with the robot assistant through voice commands, facilitating hands-free operation and enhancing the efficiency of human-robot interaction on the construction site.

In operation, the computing environment 2200 receives natural language instructions from a human worker. These instructions are captured and processed by the natural language understanding module 2212 to extract task-specific information. The information mapping module 2214 then maps this information to specific construction tasks and sequences. Finally, the robot control module 2216 generates control signals for the robot assistant to execute these tasks. This process enables human workers, who may not have expertise in robot programming, to intuitively communicate with robot assistants, enhancing efficiency and safety in construction work.

In the context of facilitating human-robot collaboration in construction work, the computing environment 2200, through its integrated modules, transforms the way construction tasks are communicated and executed on dynamic and often unpredictable construction sites. The natural language understanding module 2212 serves as the initial point of interaction between human workers and the robotic system. When a construction worker issues a command such as “Install the drywall panel on the north wall,” the natural language understanding module 2212 captures this instruction and employs sophisticated natural language processing algorithms to dissect the command. It identifies key elements such as the action “install,” the object “drywall panel,” and the location “north wall.” This module's ability to accurately interpret natural language instructions is crucial, especially in construction environments where instructions can be complex and laden with industry-specific terminology.

Once the instruction is interpreted, the information mapping module 2214 steps in to translate the human worker's command into a structured format that the robot can understand and act upon. This involves mapping the task-specific information extracted by the natural language understanding module 2212 to specific construction tasks and sequences. For instance, the command to install a drywall panel involves determining the exact location on the north wall, the orientation of the panel, and the sequence of actions the robot must perform to complete the task. The information mapping module 2214 integrates this information with data from building component information systems, such as Building Information Modeling (BIM) databases, to generate a detailed action plan for the robot. This module ensures that the robot receives precise instructions, accounting for the dynamic nature of construction sites where the environment and task requirements can change rapidly.

The robot control module 2216 is responsible for converting the mapped instructions into control signals that guide the robot assistant's actions. This module orchestrates the robot's movements, from navigating to the specified location on the construction site to performing the physical task of installing the drywall panel as instructed. The robot control module 2216 ensures that the robot's actions are synchronized with the planned tasks and sequences, allowing for adjustments in real-time based on environmental feedback and monitoring. For example, if the robot encounters an unexpected obstacle while navigating to the north wall, the robot control module 2216 can adjust the robot's path accordingly, ensuring the task's successful completion.

The computing environment 2200, as depicted in FIG. 22, is designed to facilitate seamless human-robot collaboration in construction settings, particularly in tasks requiring precision and adaptability, such as pick-and-place operations. This environment is equipped with a robust CPU 2202, capable of processing complex algorithms and managing the operations of various modules essential for the system's functionality. The memory 2204 serves as the repository for the software instructions that drive these modules, ensuring that the system can respond dynamically to the instructions received from human workers and the conditions encountered on the construction site.

The NIC 2206 enables the computing environment to communicate with external devices and systems, including robot assistants and potentially other construction management systems, through network 2208. This connectivity is crucial for coordinating tasks and sharing information in real-time, ensuring that the construction process is efficient and responsive to changes.

A database 2232 plays a vital role in storing and managing data critical for the operation of the computing environment. This may include construction project specifications, robot capabilities, and historical data on task execution, which can be leveraged by the learning and optimization module 2224 to improve the system's performance over time.

A mobile computing device 2250, with user interface 2252 and microphone 2254, acts as the primary point of interaction between human workers and the computing environment. Workers can issue voice commands captured by the microphone, which are then processed by the audio processing module 2226 to extract clear instructions. The user interface allows workers to monitor the progress of tasks, adjust priorities, and receive alerts or feedback from the system, facilitating a two-way communication channel that enhances the collaboration between humans and robots.

In a construction environment 2256, a robotic arm 2258-A exemplifies the practical application of the computing environment's capabilities. Controlled through instructions processed by the natural language understanding module 2212, information mapping module 2214, and robot control module 2216, the robotic arm can perform precise pick-and-place tasks, such as positioning beams or girders as part of the construction process. A surveying tripod 2258-B, possibly equipped with sensors, contributes to the environmental sensing and adaptation module 2218 by providing data on site conditions, which is used to adjust the robot's actions as necessary.

Building on the foundational capabilities of the computing environment 2200 as detailed above, the present techniques can be extended to a wide range of construction tasks beyond pick-and-place operations for drywall installation. These techniques leverage the system's advanced modules for natural language processing, task mapping, environmental adaptation, and more, to facilitate human-robot collaboration in various construction scenarios.

One potential use case involves precision painting and coating applications. In this scenario, the natural language understanding module 2212 can process instructions from human workers specifying areas to be painted, paint colors, and finishes. The information mapping module 2214 then translates these instructions into detailed tasks for the robot assistant, which, controlled by the robot control module 2216, executes the painting tasks with high precision. The environmental sensing and adaptation module 2218 ensures that the robot adjusts its operations based on environmental factors such as wind, which could affect the spray painting process.

Another use case could be automated bricklaying for constructing walls. Workers can issue commands specifying the layout and dimensions of the wall, and the system can use the task prioritization and scheduling module 2220 to organize these tasks efficiently. The robot, guided by precise control signals, can lay bricks accurately, applying mortar and aligning each brick with precision. The learning and optimization module 2224 can analyze data from completed sections to optimize the robot's bricklaying patterns, improving speed and reducing material waste over time.

The present techniques can also be applied to complex tasks such as installing plumbing and electrical systems within buildings. Human workers can describe the layout of pipes or wiring using natural language instructions, which are then processed to generate detailed installation plans. The robot assistants can perform tasks such as cutting pipes to length, bending them as required, or pulling wires through conduits, all under the guidance of the computing environment. The human-robot interaction interface module 2222 facilitates real-time adjustments and feedback, allowing workers to make on-the-fly changes to the installation plan based on unforeseen site conditions.

In landscaping and exterior construction work, the system can control robots to perform tasks such as grading land, laying sod, or installing hardscape elements like pavers and retaining walls. The audio processing module 2226 ensures that instructions issued outdoors are accurately captured and processed, despite background noise from construction activities or natural elements. The environmental sensing and adaptation module 2218 plays a crucial role in adjusting the robot's tasks based on soil conditions, weather, and other outdoor factors, ensuring that landscaping tasks are completed efficiently and to specification. It should be appreciated that many other applications are envisaged.

### Exemplary Computer-Implemented Methods

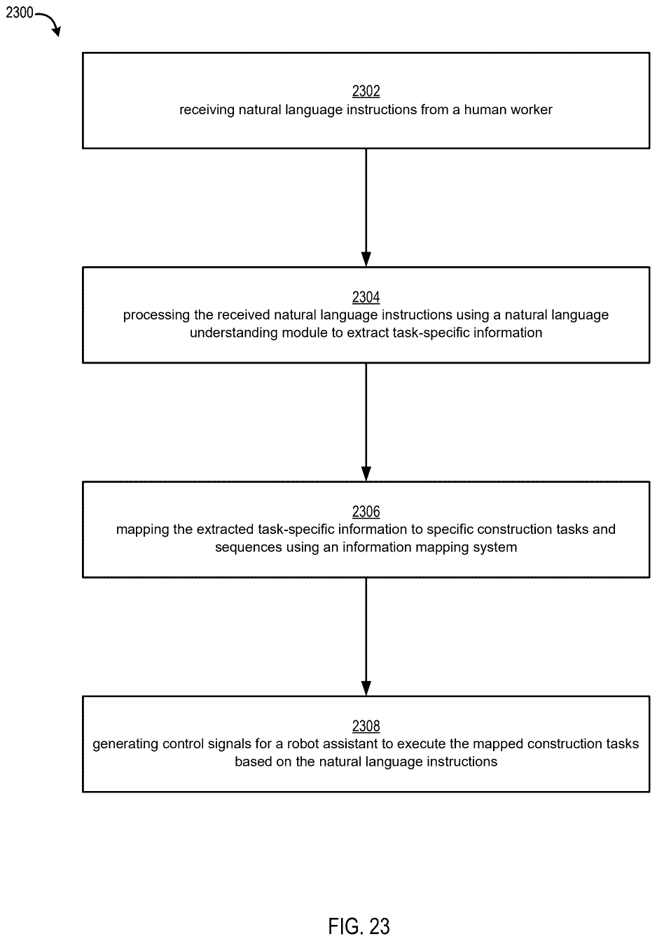

FIG. 23 depicts a computer-implemented method 2300 for facilitating human-robot collaboration in construction work. This method enables a computing system to process natural language instructions from a human worker and generate control signals for a robot assistant to execute specific construction tasks based on these instructions. The method 2300 may be described with reference to a system comprising a processor and a memory, where the memory stores computer-executable instructions that, when executed by the processor, facilitate the described method.

The method 2300 includes receiving natural language instructions from a human worker (block 2302). This step involves capturing verbal commands given by construction workers, which may include details about the task to be performed, such as the type of construction activity and specific instructions related to the task. For example, a worker might instruct the robot assistant to “place the drywall panel on the north wall.” This step is for initiating the human-robot collaboration process, where the natural language instructions serve as the primary mode of communication between the human worker and the robot assistant.

The method 2300 further includes processing the received natural language instructions using a natural language understanding module to extract task-specific information (block 2304). The natural language understanding module analyzes the verbal commands to identify key pieces of information relevant to the construction tasks. This module leverages advanced natural language processing techniques to accurately interpret the instructions, achieving over 99% accuracy in understanding and interpreting the natural language instructions. This high level of accuracy ensures that the robot assistant accurately comprehends the tasks it is instructed to perform, thereby minimizing errors in task execution.

Next, the method 2300 involves mapping the extracted task-specific information to specific construction tasks and sequences using an information mapping system (block 2306). This step translates the interpreted instructions into a format that the robot assistant can understand and act upon. The information mapping system employs conditional statements to deal with discrepancies between the outputs of the natural language understanding module and the building component information. This ensures that the robot assistant is provided with clear and actionable tasks, even when the initial instructions might be ambiguous or incomplete.

Finally, the method 2300 includes generating control signals for a robot assistant to execute the mapped construction tasks based on the natural language instructions (block 2308). This step involves converting the mapped tasks and sequences into specific commands that control the robot assistant's movements and actions. The robot assistant then performs the construction tasks, such as picking and placing materials or assembling components, as instructed by the human worker. This enables a seamless collaboration between the human worker and the robot assistant, enhancing productivity and efficiency in construction work.

The method 2300 may include capturing the natural language instructions given by the human worker in a construction environment using a speech recognition module. This involves using microphones or speech recognition hardware to accurately capture human speech in potentially noisy construction environments. The speech recognition module serves as the interface between the human worker and the computing system, ensuring that verbal commands are accurately captured and processed.

The method 2300 may further include providing feedback to the human worker regarding the status of the robot assistant's task execution through a user interface device. This feedback mechanism allows the human worker to monitor the progress of the tasks being performed by the robot assistant and make adjustments or provide additional instructions as needed. The user interface device could be a tablet, a wearable device, or any other suitable technology that facilitates communication between the human worker and the computing system.

Additionally, the method 2300 may include providing environmental feedback and monitoring the status of the construction tasks being performed by the robot assistant using sensors and cameras. This involves deploying various sensors and cameras around the construction site to collect real-time data about the environment and the tasks being performed. This data is then used to adjust the robot assistant's actions as necessary, ensuring that the tasks are performed accurately and safely.

The method 2300 may also include facilitating real-time data exchange and coordination between the human worker, the natural language understanding module, the information mapping system, and the robot assistant using communication network hardware. This step ensures that all components of the system are interconnected and can communicate with each other in real-time. This real-time data exchange and coordination are for adapting to changes in the construction environment and tasks, allowing for flexible and responsive human-robot collaboration.

The method 2300 may also include generating sets of computer-executable instructions for processing on one or more robots. For example, these instructions could be tailored to enable the robots to perform construction tasks such as installing drywall panels, laying bricks, or painting walls based on the processed natural language instructions. This process involves translating the mapped construction tasks and sequences into specific robotic actions, ensuring that the robots can execute these tasks with precision and efficiency. By using advanced algorithms and machine learning techniques, the system can optimize the generated instructions for various construction scenarios, adapting to the unique requirements of each task and the dynamic conditions of construction sites. This approach not only enhances the adaptability and effectiveness of robots in construction work but also facilitates a more intuitive and seamless collaboration between human workers and robotic assistants, ultimately contributing to improved productivity and safety in the construction industry.

### EXEMPLARY ASPECTS

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:

Aspect 1. A computing system for facilitating human-robot collaboration in construction work, comprising: a processor; and a memory having stored thereon computer-executable instructions that, when executed by the processor, cause the computing system to receive natural language instructions from a human worker; process the received natural language instructions using a natural language understanding module to extract task-specific information; map the extracted task-specific information to specific construction tasks and sequences using an information mapping system; and generate control signals for a robot assistant to execute the mapped construction tasks based on the natural language instructions.

Aspect 2. The computing system of aspect 1, further comprising a speech recognition module configured to capture the natural language instructions given by the human worker in a construction environment.

Aspect 3. The computing system of any of aspects 1-2, further comprising a user interface device to provide feedback to the human worker regarding a status of task execution by the robot assistant.

Aspect 4. The computing system of any of aspects 1-3, further comprising sensors and cameras to provide environmental feedback and monitor a status of the mapped construction tasks being performed by the robot assistant.

Aspect 5. The computing system of any of aspects 1-4, further comprising a communication network hardware to facilitate real-time data exchange and coordination between the human worker, the natural language understanding module, the information mapping system, and the robot assistant.

Aspect 6. The computing system of any of aspects 1-5, wherein the natural language understanding module is configured to achieve over 99% accuracy in understanding and interpreting the natural language instructions.

Aspect 7. The computing system of any of aspects 1-6, wherein the information mapping system employs conditional statements to deal with discrepancies between outputs of the natural language understanding module and building component information.

Aspect 8. A computer-implemented method for facilitating human-robot collaboration in construction work, comprising: receiving, by a computing system, natural language instructions from a human worker; processing, by the computing system, the received natural language instructions using a natural language understanding module to extract task-specific information; mapping, by the computing system, the extracted task-specific information to specific construction tasks and sequences using an information mapping system; and generating, by the computing system, control signals for a robot assistant to execute the mapped construction tasks based on the natural language instructions.

Aspect 9. The method of aspect 8, further comprising capturing the natural language instructions given by the human worker in a construction environment using a speech recognition module.

Aspect 10. The method of any of aspects 8-9, further comprising providing feedback to the human worker regarding a status of task execution by the robot assistant through a user interface device.

Aspect 11. The method of any of aspects 8-10, further comprising providing environmental feedback and monitoring a status of the mapped construction tasks being performed by the robot assistant using sensors and cameras.

Aspect 12. The method of any of aspects 8-11, further comprising facilitating real-time data exchange and coordination between the human worker, the natural language understanding module, the information mapping system, and the robot assistant using communication network hardware.

Aspect 13. The method of any of aspects 8-12, wherein the natural language understanding module is configured to achieve over 99% accuracy in understanding and interpreting the natural language instructions.

Aspect 14. The method of any of aspects 8-13, wherein the information mapping system employs conditional statements to deal with discrepancies between outputs of the natural language understanding module and building component information.

Aspect 15. A computer-readable medium having stored thereon instructions that, when executed by a computing system, cause the computing system to perform a method for facilitating human-robot collaboration in construction work, the method comprising: receiving natural language instructions from a human worker; processing the received natural language instructions using a natural language understanding module to extract task-specific information; mapping the extracted task-specific information to specific construction tasks and sequences using an information mapping system; and generating control signals for a robot assistant to execute the mapped construction tasks based on the natural language instructions.

Aspect 16. The computer-readable medium of aspect 15, wherein the method further comprises capturing the natural language instructions given by the human worker in a construction environment using a speech recognition module.

Aspect 17. The computer-readable medium of any of aspects 15-16, wherein the method further comprises providing feedback to the human worker regarding a status of task execution by the robot assistant through a user interface device.

Aspect 18. The computer-readable medium of any of aspects 15-17, wherein the method further comprises providing environmental feedback and monitoring a status of the mapped construction tasks being performed by the robot assistant using sensors and cameras.

Aspect 19. The computer-readable medium of any of aspects 15-18, wherein the method further comprises facilitating real-time data exchange and coordination between the human worker, the natural language understanding module, the information mapping system, and the robot assistant using communication network hardware.

Aspect 20. The computer-readable medium of any of aspects 15-19, wherein the natural language understanding module is configured to achieve over 99% accuracy in understanding and interpreting the natural language instructions, and the information mapping system employs conditional statements to deal with discrepancies between outputs of the natural language understanding module and building component information.

### ADDITIONAL CONSIDERATIONS

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean.” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computing system for facilitating human-robot collaboration in construction work, comprising:
a processor; and
a memory having stored thereon computer-executable instructions that, when executed by the processor, cause the computing system to:
receive natural language instructions from a human worker;
process the received natural language instructions using a natural language understanding module to extract task-specific information;
map the extracted task-specific information to specific construction tasks and sequences using an information mapping system; and
generate control signals for a robot assistant to execute the mapped construction tasks based on the natural language instructions.

2. The computing system of claim 1, further comprising a speech recognition module configured to capture the natural language instructions given by the human worker in a construction environment.

3. The computing system of claim 2, further comprising a user interface device to provide feedback to the human worker regarding a status of task execution by the robot assistant.

4. The computing system of claim 1, further comprising sensors and cameras to provide environmental feedback and monitor a status of the mapped construction tasks being performed by the robot assistant.

5. The computing system of claim 1, further comprising a communication network hardware to facilitate real-time data exchange and coordination between the human worker, the natural language understanding module, the information mapping system, and the robot assistant.

6. The computing system of claim 1, wherein the natural language understanding module is configured to achieve over 99% accuracy in understanding and interpreting the natural language instructions.

7. The computing system of claim 1, wherein the information mapping system employs conditional statements to deal with discrepancies between outputs of the natural language understanding module and building component information.

8. A computer-implemented method for facilitating human-robot collaboration in construction work, comprising:
receiving, by a computing system, natural language instructions from a human worker;
processing, by the computing system, the received natural language instructions using a natural language understanding module to extract task-specific information;
mapping, by the computing system, the extracted task-specific information to specific construction tasks and sequences using an information mapping system; and
generating, by the computing system, control signals for a robot assistant to execute the mapped construction tasks based on the natural language instructions.

9. The method of claim 8, further comprising capturing the natural language instructions given by the human worker in a construction environment using a speech recognition module.

10. The method of claim 8, further comprising providing feedback to the human worker regarding a status of the task execution by the robot assistant through a user interface device.

11. The method of claim 8, further comprising providing environmental feedback and monitoring a status of the mapped construction tasks being performed by the robot assistant using sensors and cameras.

12. The method of claim 8, further comprising facilitating real-time data exchange and coordination between the human worker, the natural language understanding module, the information mapping system, and the robot assistant using communication network hardware.

13. The method of claim 8, wherein the natural language understanding module is configured to achieve over 99% accuracy in understanding and interpreting the natural language instructions.

14. The method of claim 8, wherein the information mapping system employs conditional statements to deal with discrepancies between outputs of the natural language understanding module and building component information.

15. A computer-readable medium having stored thereon instructions that, when executed by a computing system, cause the computing system to:
perform a method for facilitating human-robot collaboration in construction work, the method comprising:
receiving natural language instructions from a human worker;
processing the received natural language instructions using a natural language understanding module to extract task-specific information;
mapping the extracted task-specific information to specific construction tasks and sequences using an information mapping system; and
generating control signals for a robot assistant to execute the mapped construction tasks based on the natural language instructions.

16. The computer-readable medium of claim 15, wherein the method further comprises capturing the natural language instructions given by the human worker in a construction environment using a speech recognition module.

17. The computer-readable medium of claim 15, wherein the method further comprises providing feedback to the human worker regarding a status of task execution by the robot assistant task execution through a user interface device.

18. The computer-readable medium of claim 15, wherein the method further comprises providing environmental feedback and monitoring a status of the mapped construction tasks being performed by the robot assistant using sensors and cameras.

19. The computer-readable medium of claim 15, wherein the method further comprises facilitating real-time data exchange and coordination between the human worker, the natural language understanding module, the information mapping system, and the robot assistant using communication network hardware.

20. The computer-readable medium of claim 15, wherein the natural language understanding module is configured to achieve over 99% accuracy in understanding and interpreting the natural language instructions, and the information mapping system employs conditional statements to deal with discrepancies between outputs of the natural language understanding module and building component information.
